(19) United States
(12) Patent Application Publication
(10) Pub. No.: US 2004/0218221 A1
(43) Pub. Date: Nov. 4, 2004

(54) Threshold value matrix creating method, image output system, storage medium, gradation reproducing method, threshold value matrix, image processing method, image processing apparatus, image forming apparatus and printer driver

(76) Inventors: Masanori Hirano, Tokyo (JP); Masakazu Yoshida, Tokyo (JP)

Correspondence Address: Ivan S Kavrukov, Cooper & Dunham, 1185 Avenue of the Americas, New York, NY, 10036, US

(21) Appl. No.: 10/487,376

(22) PCT Filed: Sep. 20, 2002
(86) PCT No.: PCT/JP02/09726

(30) Foreign Application Priority Data
Sep. 21, 2001 (JP) 2001288030
Jun. 21, 2002 (JP) 2002181486
Jul. 18, 2002 (JP) 2002209907

(51) Int. Cl. H04N 1/405; G06K 15/00

(52) U.S. Cl. 358/3.06

(57) ABSTRACT

A threshold matrix creating method creates threshold value matrixes for quantizing multi-level image data into three or more valued data in order to represent halftone by ON and OFF states of a plurality of kinds of dots. The method includes a first stage which determines a threshold value layout order of the threshold value matrixes for binarizing the multi-level image data in order to represent the halftone by ON and OFF states of one kind of dot, and a second stage which creates each of threshold value matrixes for quantizing the multi-level image data into three or more valued data, according to the threshold value layout order determined by the first stage.

### TECHNICAL FIELD

The present invention generally relates to threshold value matrix creating methods, image output systems, storage media, gradation reproducing methods, threshold value matrixes, image processing methods, image processing apparatuses, image forming apparatuses and printer drivers, and more particularly to a threshold value matrix which is used for quantizing a multi-level (or multi-valued) image data into three or more valued data in order to represent halftone by ON and OFF states of a plurality of kinds of dots having different sizes, different tones or luminances, or different sizes and tones or luminances.

### BACKGROUND ART

The methods of creating a halftone image by a digital image processing can generally be categorized into two types, namely, the dither method and the error diffusion (or scattering) method. The dither method requires a relatively small amount of computing process, and is capable of carrying out a high-speed processing. Hence, the dither method is suited for a case where the picture quality is in a low to medium range, but requires measures to be taken with respect to the moiré. On the other hand, the error diffusion method requires a relatively large amount of computing process when compared to the dither method, and it is difficult to realize a high-speed processing. Thus, the error diffusion method is suited for a case where the picture quality is high. Accordingly, both the dither method and the error diffusion method have advantages and disadvantages, and are selectively used depending on the application, namely, the structure of an image output apparatus and the kind of target image which is to be processed.

Halftone processing methods have also been proposed, which incorporate the advantages features of the dither method and the error diffusion method. Generally, these halftone processing methods are often referred to as the FM mask method, the FM screen method and the blue noise mask method. These halftone processing methods are closer to the dither method, and are techniques which employ the diffusion type matrix comparison method similarly to the Bayer type.

The FM mask method uses a threshold value matrix having a frequency characteristic (blue noise (BN) characteristic) which is formed solely from the high-frequency components and excludes the low-frequency components. Although the FM mask method is a mask comparison method, it is possible to make inconspicuous the periodic property of the low-frequency components which are observed in the case of the Bayer type dither and the dot concentration type dither. As a result, the FM mask method has a high resistance against the moiré, and can obtain a resolution characteristic comparable to that obtained by the error diffusion method. For this reason, the FM mask method is considered promising in the field of printing.

A method of creating an ideal FM mask was proposed in a Japanese Patent No.2622429. According to this proposed method, a completely random (white noise) dot pattern is subjected to a Fourier transform, filtered by a filter having a BN characteristic, and then subjected to an inverse Fourier transform to obtain the ideal FM mask.

On the other hand, a method of optimizing the mask was proposed by Robert Ulichney, “The Void-And-Cluster Method For Dither Array Generation”, SPIE, Vol. 1913. This proposed method optimizes the mask by comparing a void portion where the dots are sparse and a cluster portion where the dots are dense and carrying out a dot transformation.

Both of these two proposed methods use a random pattern as the initial pattern. Hence, a computation result which is finally obtained assumes a different value each time. In addition, there is a problem in that an extremely long computation time is required depending on the mask size, because it is necessary to make a restructuring from an irregular distribution state to a uniform distribution state.

A method of eliminating this problem was proposed in a Japanese Laid-Open Patent Application No.8-80641. This method uses an initial pattern which is created by an error diffusion process as a starting point. According to this method, the designer can arbitrarily control a starting mask which becomes the starting point. For this reason, it is possible to secure recursion of the computation result by eliminating the accidental elements. In addition, since the uniform distribution can be obtained in the initial state, it is not only possible to improve the quality of the mask which is finally created, but to also reduce the computation time.

However, according to the successive determination which successively optimizes one gradation at a time from the initial pattern which is used as the starting point, a dot layout which is next selected becomes limited by the dot layout pattern which is determined immediately before. Even if it is assumed that the initial pattern is capable of forming a perfect dot layout in terms of the resistances to granularity and texture, this only applies to the gradation level at the starting point. For the next gradation level which is added with or reduced by several dots with respect to the dot layout, the dot layout is no longer perfect although a high quality is still obtainable. As the gradation level progresses, the error from the perfect dot layout is successively accumulated, and the dot layout for the final gradation levels may become far from the optimum dot layout.

FIG. 1 is a diagram showing such a quality deterioration of the dot layout. The dot layout deteriorates towards the right side of FIG. 1.

In order to suppress the quality deterioration of the dot layout, various optimizing functions and dot layout search methods have been proposed. However, these proposed methods all employ the technique which creates the threshold value matrix by starting from a specific gradation level (1/2555 or 128/2555) and successively obtaining the dot position one dot at a time. For this reason, the problem of accumulating limitations caused by the immediately preceding gradation level remains, and no drastic improvement can be expected from these proposed methods.

In addition, in order to add an ideal BN characteristic to the threshold value matrix, the threshold value matrix must have an extremely large size depending on the resolution. From results of various researches, it has been found that the threshold value matrix must have a size of at least 256×256 with respect to an image having a resolution of 600 dpi, and the size of the threshold value matrix must be greater for larger resolutions. When considering the fact that the existing diffusion type dither matrix that is generally used has a size of 4×4 to 16×16, the threshold value matrix is extremely large. But when the matrix becomes extremely large, it becomes difficult to construct an image forming apparatus which employs the dither method which enables the high-speed processing. The load of the computation process required to create the mask in particular becomes too large.

Recently, image forming apparatuses such as printers have begun employing a method of representing halftone by ON and OFF states of two or more kinds of dots having different sizes, different tones or luminances, or different sizes and tones or luminances. According to such a halftone representation method, it is necessary to prepare a threshold value matrix corresponding to each kind of dot, and to quantize the multilevel image data to three or more valued data.

### DISCLOSURE OF THE INVENTION

It is a general object of the present invention to provide a novel and useful threshold value matrix creating method, image output system, storage medium, gradation reproducing method, threshold value matrix, image processing method, image processing apparatus, image forming apparatus and printer driver, in which the problems described above are eliminated.

A more specific object of the present invention is to provide a threshold value matrix creating method and storage medium, which can efficiently create the threshold value matrix for representing halftone with a high quality by ON and OFF states of a plurality of kinds of dots.

Another specific object of the present invention is to provide an image output system which can realize a high-quality halftone representation using such a threshold value matrix.

Still another specific object of the present invention is to provide a threshold matrix creating method which creates a plurality of threshold value matrixes for quantizing multi-level image data into three or more valued data in order to represent halftone by ON and OFF states of a plurality of kinds of dots, comprising a first stage which determines a threshold value layout order of the threshold value matrixes for binarizing the multi-level image data in order to represent the halftone by ON and OFF states of one kind of dot; and a second stage which creates each of a plurality of threshold value matrixes for quantizing the multi-level image data into three or more valued data, according to the threshold value layout order determined by the first stage. According to the threshold value matrix creating method of the present invention, a common basic layout (threshold value layout order) is used for a plurality of threshold value matrixes, so that a consistent diffusion characteristic can be given to the various kinds of dots having the different dot diameters, for example, even when the threshold value matrixes are switched depending on the gradation level when quantizing the multi-level image data. For this reason, it is possible to prevent the different kinds of dots from interfering with each other and generating different textures having different period or base. In addition, since the layout order of the various kinds of dots is constant, it is possible to prevent an unwanted isolated dot from being generated when a large dot happens to be arranged in a gap of the matrix pattern. Moreover, the threshold value layout order of the plurality of threshold value matrixes can be optimized by the bi-level (binary) data, which means optimization with the dots having the maximum size. Hence, by improving the diffusion characteristic of the dots which have the maximum size and most easily affect the granularity, it is possible to simultaneously improve the granularity of the medium and small dots which are less conspicuous to the human eye, to thereby improve the granularity of the entire image.

In the threshold value matrix creating method, the first stage may include selecting random gradation levels from all gradation sections; determining a dot layout of the selected gradation level according to optimizing conditions; determining a dot layout of each gradation level between a starting side gradation level and an ending side gradation level which are selected, according to the optimizing conditions based on optimized dot layouts of the starting side and ending side gradation levels; and determining the threshold value layout order of the threshold value matrixes for the binarization, based on the determined dot layout of each gradation level. According to the threshold value matrix creating method of the present invention, it is possible to suppress the accumulation of the error from the optimum dot layout, by optimizing the dot layout at selected gradation level intervals. Hence, it is possible to avoid quality deterioration of the dot layout which would otherwise gradually occur depending on the change in gradation level in the case of the general FM screen.

In the threshold value matrix creating method, the first stage may include carrying out an adjusting process to include the optimized dot layout of the starting side gradation level in an initial dot layout pattern of the ending side gradation level; and determining the dot layout of the ending side gradation level according to the optimizing conditions, based on the initial dot layout pattern after the adjusting process, while maintaining the dot layout of the starting side gradation level. According to the threshold value matrix creating method of the present invention, it is possible to secure continuity of the gradation levels, and effectively prevent the generation of pseudo contour and texture.

A further object of the present invention is to provide a computer-readable storage medium which stores a program for causing a computer to create a plurality of threshold value matrixes for quantizing multi-level image data into three or more valued data in order to represent halftone by ON and OFF states of a plurality of kinds of dots, where the program comprises a first procedure which causes the computer to determine a threshold value layout order of the threshold value matrixes for binarizing the multi-level image data in order to represent the halftone by ON and OFF states of one kind of dot; and a second procedure stage which causes the computer to create each of a plurality of threshold value matrixes for quantizing the multi-level image data into three or more valued data, according to the threshold value layout order determined by the first procedure. According to the computer-readable storage medium of the present invention, a common basic layout (threshold value layout order) is used for a plurality of threshold value matrixes, so that a consistent diffusion characteristic can be given to the various kinds of dots having the different dot diameters, for example, even when the threshold value matrixes are switched depending on the gradation level when quantizing the multi-level image data.

Another object of the present invention is to provide an image output system comprising a first section which determines a threshold value layout order of a plurality of threshold value matrixes for binarizing the multi-level image data in order to represent the halftone by ON and OFF states of one kind of dot; a second section which creates each of a plurality of threshold value matrixes for quantizing the multi-level image data into three or more valued data, according to the threshold value layout order determined by the first section; and a third section which quantizes the multi-level image data into the three or more valued data in order to represent halftone by ON and OFF states of a plurality of kinds of dots, using the threshold value matrix created by the second section. According to the image output system of the present invention, a common basic layout (threshold value layout order) is used for a plurality of threshold value matrixes, so that a consistent diffusion characteristic can be given to the various kinds of dots having the different dot diameters, for example, even when the threshold value matrixes are switched depending on the gradation level when quantizing the multi-level image data. The image output system may have a structure made up of a general purpose computer such as a personal computer and an image forming apparatus such as a printer or, a structure made up solely of an image forming apparatus such as the printer.

Still another specific object of the present invention is to provide a gradation reproducing method, threshold value matrix, image processing method, image processing apparatus, image forming apparatus and printer driver, which can realize a satisfactory picture quality even at a low resolution and/or during a high-speed recording.

A further object of the present invention is to provide a gradation reproducing method comprising converting a multi-gradation image into a bi-level or multi-level image data representing each dot by a bi-level or multi-level representation using a dither matrix, where the dither matrix has a line keytone in a predetermined direction for at least some of tones of the multi-gradation image, and has a highpass filter characteristic at portions other than the line keytone. According to the gradation reproducing method of the present invention, it is possible to suppress deterioration of the resolution and improve the continuity of the line keytone, so that a high picture quality is obtained even during recording at a low resolution and/or a high speed.

In the gradation reproducing method, a difference image of two bi-level images corresponding to certain tones of the dither matrix may have a highpass filter characteristic.

In the gradation reproducing method, power spectrum distributions for angles other than the line keytone in the predetermined direction in polar coordinates due to two-dimensional spatial frequency may be uniformly similar for certain tones of the dither matrix.

In the gradation reproducing method, the keytone may be a line-group keytone.

Another object of the present invention is to provide a threshold value matrix for converting a multi-gradation image into a bi-level or multi-level image data representing each dot by a bi-level or multi-level representation, comprising a line keytone in a predetermined direction for at least some of tones of the multi-gradation image; and a highpass filter characteristic at portions other than the line keytone. According to the threshold value matrix of the present invention, it is possible to suppress deterioration of the resolution and improve the continuity of the line keytone, so that a high picture quality is obtained even during recording at a low resolution and/or a high speed.

In the threshold value matrix, a difference image of two bi-level images corresponding to certain tones of the dither matrix may have a highpass filter characteristic. In addition, power spectrum distributions for angles other than the line keytone in the predetermined direction in polar coordinates due to two-dimensional spatial frequency may be uniformly similar for certain tones of the dither matrix. Further, the keytone may be a line-group keytone.

Still another object of the present invention is to provide an image processing method comprising decomposing a multi-color image into a plurality of color components; and converting an original image of at least one of the color components into a bi-level or multi-level image data representing each dot by a bi-level or multi-level representation using a dither matrix, where the dither matrix has a line keytone in a predetermined direction for at least some of tones of the multi-gradation image, and has a highpass filter characteristic at portions other than the line keytone. According to the image processing-method of the present invention, it is possible to suppress deterioration of the resolution and improve the continuity of the line keytone, so that a high picture quality is obtained even during recording at a low resolution and/or a high speed.

A further object of the present invention is to provide an image processing apparatus comprising a section which decomposes a multi-color image into a plurality of color components; and a section which converts an original image of at least one of the color components into a bi-level or multi-level image data representing each dot by a bi-level or multi-level representation using a dither matrix, where the dither matrix has a line keytone in a predetermined direction for at least some of tones of the multi-gradation image, and has a highpass filter characteristic at portions other than the line keytone. According to the image processing apparatus of the present invention, it is possible to suppress deterioration of the resolution and improve the continuity of the line keytone, so that a high picture quality is obtained even during recording at a low resolution and/or a high speed.

Another object of the present invention is to provide an image processing apparatus comprising means for decomposing a multi-color image into a plurality of color components; and means for converting an original image of at least one of the color components into a bi-level or multi-level image data representing each dot by a bi-level or multi-level representation using a dither matrix, where the dither matrix has a line keytone in a predetermined direction for at least some of tones of the multi-gradation image, and has a highpass filter characteristic at portions other than the line keytone. According to the image processing apparatus of the present invention, it is possible to suppress deterioration of the resolution and improve the continuity of the line keytone, so that a high picture quality is obtained even during recording at a low resolution and/or a high speed.

Still another object of the present invention is to provide an image forming apparatus comprising a decomposing section which decomposes a multi-color image into a plurality of color components; a converting section which converts an original image of at least one of the color components into a bi-level or multi-level image data representing each dot by a bi-level or multi-level representation using a dither matrix; and an imaging section which forms an image from a plurality of dots depending on an output of the converting section, where the dither matrix has a line keytone in a predetermined direction for at least some of tones of the multi-gradation image, and has a highpass filter characteristic at portions other than the line keytone. According to the image forming apparatus of the present invention, it is possible to suppress deterioration of the resolution and improve the continuity of the line keytone, so that a high picture quality is obtained even during recording at a low resolution and/or a high speed.

A further object of the present invention is to provide an image forming apparatus comprising decomposing means for decomposing a multi-color image into a plurality of color components; converting means for converting an original image of at least one of the color components into a bi-level or multi-level image data representing each dot by a bi-level or multi-level representation using a dither matrix; and imaging means for forming an image from a plurality of dots depending on an output of the converting means, where the dither matrix has a line keytone in a predetermined direction for at least some of tones of the multi-gradation image, and has a highpass filter characteristic at portions other than the line keytone. According to the image forming apparatus of the present invention, it is possible to suppress deterioration of the resolution and improve the continuity of the line keytone, so that a high picture quality is obtained even during recording at a low resolution and/or a high speed.

In the image forming apparatus, the imaging means may form the image on a recording medium by a recording technique selected from a group consisting of an ink-jet recording, a thermal transfer recording, and electrophotography recording.

Another object of the present invention is to provide a printer driver, to be implemented in a computer, for supplying an output image data to an image forming apparatus which forms an image from a plurality of dots, comprising decomposing means for decomposing a multi-color image into a plurality of color components; and converting means for converting an original image of at least one of the color components into a bi-level or multi-level image data representing each dot by a bi-level or multi-level representation using a dither matrix, so as to generate the output image data, where the dither matrix has a line keytone in a predetermined direction for at least some of tones of the multi-gradation image, and has a highpass filter characteristic at portions other than the line keytone. According to the printer driver of the present invention, it is possible to suppress deterioration of the resolution and improve the continuity of the line keytone, so that a high picture quality is obtained even during recording at a low resolution and/or a high speed.

Other objects and further features of the present invention will be apparent from the following detailed description when read in conjunction with the accompanying drawings.

### BRIEF DESCRIPTION OF THE DRAWINGS

FIG. 1 is a diagram showing such a quality deterioration of the dot layout;

FIG. 2 is a flow chart generally showing an embodiment o a threshold value matrix creating method according to the present invention;

FIG. 3 is a diagram for explaining a threshold value matrix and a basic layout thereof;

FIG. 4 is a diagram for explaining selection of starting side and ending side gradation levels;

FIG. 5 is a diagram for explaining a dot pattern introduced by sweeping of an error diffusion process;

FIG. 6 is a diagram for explaining evaluation value computation by an optimization filter;

FIG. 7 is a diagram for explaining an application range of the optimization filter;

FIGS. 8A, 8B and 8C are diagrams for explaining a relationship of dot alignment and matrix size and an angle of correction;

FIG. 9 is a diagram for explaining an adjusting process that is carried out before an optimization process for optimizing the dot layout of the ending side gradation level;

FIGS. 10A and 10B are diagrams for explaining optimized dot layouts for the starting side and ending side gradation levels;

FIGS. 11A, 11B and 11C are diagrams for explaining optimization of dot positions at gradation levels between the starting side and ending side gradation levels;

FIG. 12 is a system block diagram showing an image forming apparatus which represents halftone by four-valued data;

FIG. 13 is a diagram for explaining a dot switching method which is employed when making a gradation representation using large, medium and small dots;

FIG. 14 is a diagram showing the structure of an embodiment of an image output system according to the present invention;

FIG. 15 is a diagram showing the structure of another embodiment of the image output system according to the present invention;

FIGS. 16A, 16B and 16C are diagrams for explaining dot layout patterns which are used when carrying out the general binarization process and multi-level process;

FIGS. 17A, 17B and 17C are diagrams for explaining the systematic dither method;

FIG. 18 is a diagram showing a correspondence between size modulated dots and dither mask;

FIGS. 19A, 19B and 19C are diagrams respectively showing the threshold value matrixes for the small, medium and large dots;

FIG. 20 is a diagram for explaining a bi-level error diffusion technique;

FIG. 21 is a perspective view showing a structure of a first embodiment of the image forming apparatus according to the present invention;

FIG. 22 is a side view showing the structure of the first embodiment of the image forming apparatus;

FIG. 23 is a disassembled perspective view of a recording head;

FIG. 24 is a cross sectional view of the recording head along a longitudinal direction of an ink chamber;

FIG. 25 is an enlarged view showing an important part of FIG. 24;

FIG. 26 is a cross sectional view of the recording head along a shorter side of the ink chamber;

FIG. 27 is a plan view showing a nozzle plate of the recording head;

FIG. 28 is a system block diagram generally showing a controller of the ink-jet printer;

FIG. 29 is a system block diagram showing a driving and control section of the controller;

FIG. 30 is a system block diagram showing a head driving circuit;

FIG. 31 is a timing diagram for explaining the operation of the driving and control section;

FIG. 32 is a system block diagram showing an embodiment of an image processing apparatus according to the present invention;

FIGS. 33A, 33B and 33C are diagrams for explaining a dot pattern after carrying out a Bayer type dither process and an error diffusion process with respect to an input image;

FIGS. 34A and 34B are diagrams for explaining an image data after carrying out the Bayer type dither process with respect to an input image;

FIG. 35 is a diagram showing the granularity measured at tone intervals of 10% for the Bayer type dither pattern and the error diffusion pattern recorded at 300 dpi;

FIG. 36 is a diagram for explaining the effects of mechanical deviations in the ink-jet printer;

FIGS. 37A and 37B are diagrams for explaining interference between the Bayer type dither pattern and the mechanical deviations of the ink-jet printer;

FIGS. 38A and 38B are diagrams for explaining a dot layout pattern having an inclined keytone in an embodiment of a threshold value matrix according to the present invention;

FIGS. 39A and 39B are diagrams for explaining the dot pattern of a line-group keytone used in electrophotography recording and the change in keytone of the gradation level;

FIGS. 40A and 40B are diagrams for explaining the dot pattern of the line-group keytone applied to ink-jet recording and the change in keytone of the gradation level;

FIGS. 41A, 41B and 41C are diagrams for explaining the keytone formed by tiling a dither mask;

FIGS. 42A, 42B and 42C are diagrams for explaining the tiling and the keytone for a case where the mask has one dot per gradation level;

FIGS. 43A, 43B and 43C are diagrams for explaining the tiling and the keytone for a case where the mask has two dots per gradation level;

FIGS. 44A, 44B and 44C are diagrams for explaining the tiling and the keytone for a case where the mask has three dots per gradation level;

FIGS. 45A, 45B, 45C, 45D, 45E and 45F are diagrams for explaining division of a basic matrix into sub matrixes;

FIGS. 46A and 46B are diagrams for explaining matrix patterns having a line keytone in a predetermined direction;

FIGS. 47A and 47B are diagrams for explaining a gradation image and a matrix pattern having reduced resolution for a certain tone;

FIG. 48 is a diagram for explaining the human visual characteristic;

FIGS. 49A and 49B are diagrams for explaining a portion, other than a keytone, of a matrix pattern having a highpass filter characteristic;

FIGS. 50A, 50B, 50C and 50D are diagrams for explaining a gradation image formed by a matrix having a predetermined line keytone and a highpass filter characteristic at a portion other than the keytone;

FIGS. 51A, 51B, 51C, 51D and 51E are diagrams for explaining a difference image between matrixes of some tones;

FIGS. 52A and 52B are diagrams for explaining a power spectrum distribution in polar coordinates of the matrix;

FIG. 53 is a diagram for explaining a power spectrum distribution in polar coordinates of a conventional Bayer type dither matrix;

FIG. 54 is a diagram for explaining a power spectrum distribution in polar coordinates of a conventional concentration type dither matrix;

FIG. 55 is a system block diagram showing another embodiment of the image forming apparatus according to the present invention;

FIG. 56 is a diagram generally showing a thermal transfer type image forming apparatus;

FIG. 57 is a diagram generally showing an electrophotography type image forming apparatus;

FIG. 58 is a diagram generally showing a process cartridge of the electrophotography type image forming apparatus; and

FIG. 59 is a timing diagram for explaining a dot size change in the electrophotography type image forming apparatus.

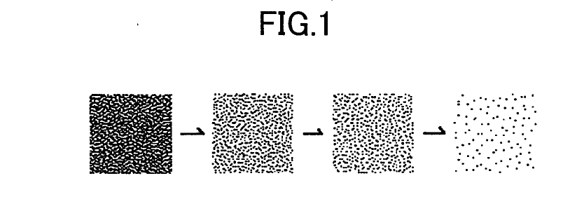

### BEST MODE FOR CARRYING OUT THE INVENTION

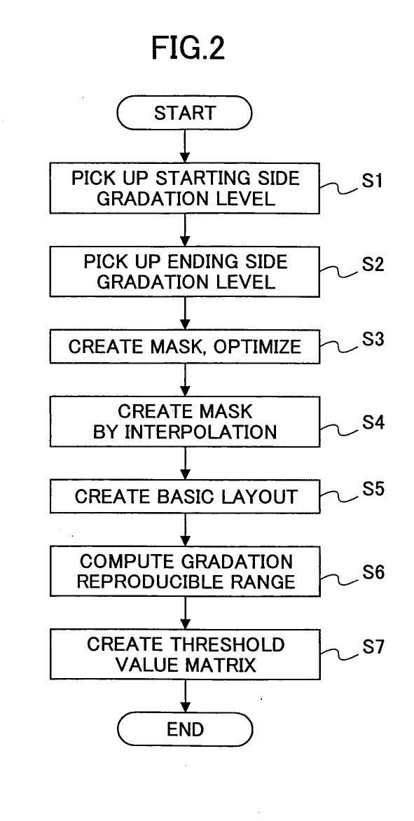

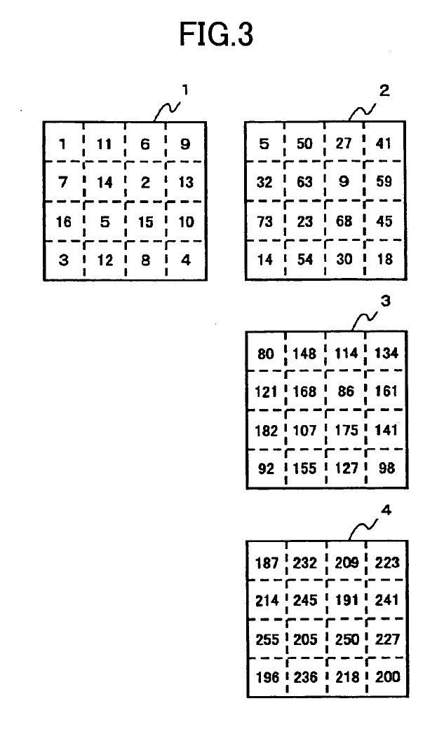

FIG. 2 is a flow chart generally showing an embodiment of a threshold value matrix creating method according to the present invention. FIG. 3 is a diagram for explaining threshold value matrix which is created by this embodiment, and a basic layout of the threshold value matrix.

In FIG. 2, steps S1 through S5 carry out a process to create a basic layout 1 shown in FIG. 3. In addition, steps S6 and S7 carry out a process to create threshold value matrixes 2, 3 and 4 shown in FIG. 3 according to the common basic layout 1. These processes may be realized by software using a general purpose computer having a known structure. A program which causes the computer to carry out these processes and a computer-readable storage medium which stores such a program also fall within the scope of the present invention.

In FIG. 3, the matrix 2 is for the small dot, where the tone is 0.4 for the non-segmented image with 100% small dots, the tone is 1.4 for the non-segmented image with 100% maximum size dots, the number of gradation levels allocated for the small dots is 73/255, and the threshold value interval is 4.5. In addition, the matrix 3 is for the medium dot, where the tone is 1.0 for the non-segmented image with 100% medium dots, the tone is 1.4 for the non-segmented image with 100% maximum size dots, the number of gradation levels allocated for the medium dots is 109/255, and the threshold value interval is 6.8 Further, the matrix 4 is for the large dot, where the tone is 1.4 for the non-segmented image with 100% large dots, the number of gradation levels allocated for the large dots is 73/255, and the threshold value interval is 4.5.

For the sake of convenience, a description will be given of a case where the halftone representation is made by ON and OFF states of three kinds of dots having different diameters, namely, small, medium and large dots. However, the present invention can of course be similarly applied to creation of the threshold value matrix for making the halftone representation using two or more kinds of dots having different sizes, different tones or luminances, or different sizes and tones or luminances.

The process of the steps S1 through S5 is carried out by assuming a case where the halftone is represented by the ON and OFF states of one kind of dot, that is, the halftone is represented by bi-level data.

The steps S1 and S2 pick up a pair of starting side gradation level and ending side gradation level, from a representable gradation section of 256 gradation levels from a gradation level 0 to a gradation level 256, for example. The starting side gradation level and the ending side gradation level are not continuous, and a plurality of gradation levels must exist between the starting side and ending side gradation levels. In addition, the starting side gradation level is more on the highlight side than the ending side gradation level. The gradation levels are picked up from the highlight side towards the shadow side. The step S3 determines the dot layout for the starting side and ending side gradation levels which are picked up, using only one kind of dot.

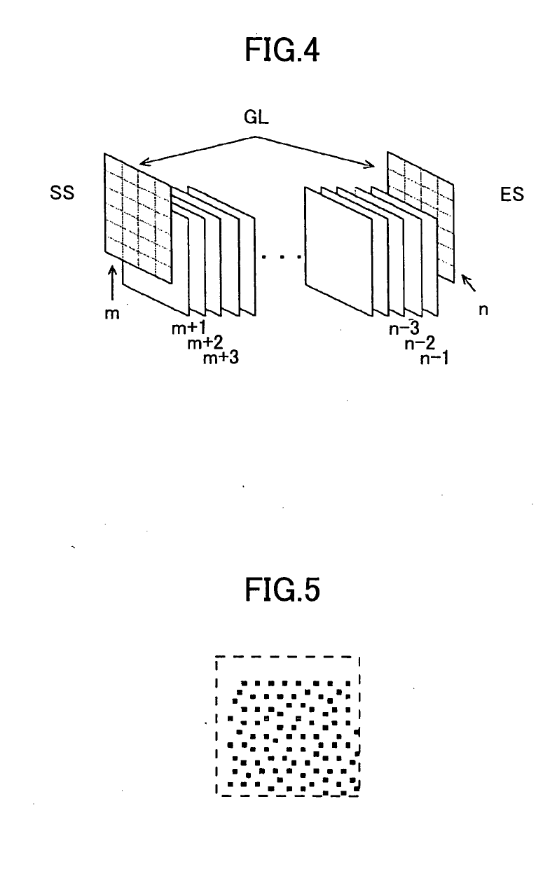

The steps S1 through S3 will now be described in more detail, by referring to FIGS. 4 through 11.

First, as shown in FIG. 4, it is assumed for the sake of convenience that the steps S1 and S2 pick up a gradation level m as the starting side gradation level and a gradation level n as the ending side gradation level. FIG. 4 is a diagram for explaining selection of the starting side and ending side gradation levels. In FIG. 4, the picked up gradation levels are indicated by an arrow GL, the starting side (highlight side) is indicated by SS, the ending side (shadow side) is indicated by ES, and the gradation levels are indicated by m, m+1, m+2, m+3, . . . and by n, n=1, n−2, n−3, . . . .

Then, the step S3 prepares an initial dot layout pattern for the starting side gradation level m, and determines an optimized dot layout by evaluating the initial dot layout using an evaluation function.

A dot pattern obtained by processing a non-segmented image having the gradation level m by the error diffusion method or the existing diffusion type dither may be used as the initial dot layout pattern. With respect to the highlight region (a gradation section from the gradation level 0 to a specific gradation level), the dot pattern which is obtained by carrying out processing by the existing diffusion type dither such as the Bayer type is more preferable as the initial dot layout pattern from the point of view of the granularity, although it also depends on the resolution. However, it is undesirable to use a white noise pattern as the initial dot layout pattern, because the load of the computation process is extremely large when adding the diffusion and combining the threshold value matrixes and when making an adjustment to maintain continuity of the gradation levels. Further, a poor local solution is easily obtained during the optimization process.

The optimization process is required because the problems peculiar to the processing method employed when creating the initial dot layout pattern are also reflected to the initial dot layout pattern. FIG. 5 is a diagram for explaining a dot pattern introduced by sweeping of the error diffusion process. In FIG. 5, a gap is formed at a top portion due to the sweeping which is a problem peculiar to the error diffusion process. A dot alignment in the vertical and horizontal directions observed in the dot pattern obtained by the Bayer type dither is easily recognized as texture, and the optimization process is also required in this case since the dot alignment may interfere with the main and sub scan operations of the image forming apparatus to thereby generate banding.

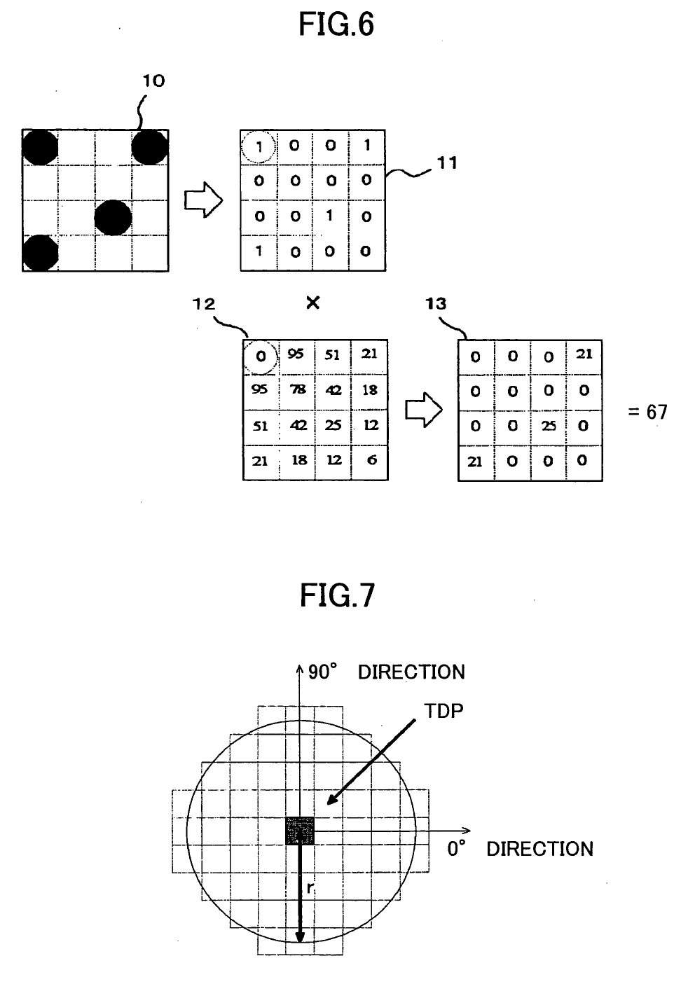

Next, the step S3 carries out the optimization process with respect to the starting side initial dot layout pattern according to optimizing conditions. More particularly, with respect to a pattern matrix 11 having a value “1” for the dot having the ON state in the initial dot layout pattern and having a value “0” for the dot having the OFF state in the initial dot layout pattern, each ON dot is regarded as a target dot and an optimization filter 12 having a predetermined size is multiplied to compute an evaluation value, as shown in FIG. 6. Moreover, the ON and OFF states of the dots are rearranged so that a total of evaluation values 13 computed for each of the target dots becomes a minimum. Compared to the Blue Noise (BN) method using the Fourier transform, this method can realize the optimization using simple filtering. FIG. 6 is a diagram for explaining the evaluation value computation by the optimization filter 12. In FIG. 6, a circular mark indicated by a dotted line indicates the target dot position in the pattern matrix 11 and the optimization filter 12. In addition, an evaluation value for the first target dot is 67 as shown for the evaluation values 13.

In FIG. 6, the optimization filter 12 has the same size as a matrix 10 of the initial dot layout pattern, in order to simplify the description. However, the optimization filter 12 is actually a circular filter as may be seen from FIG. 7, having a size smaller than the matrix 10 of the initial dot layout pattern. FIG. 7 is a diagram for explaining an application range of the optimization filter 12. In FIG. 7, the target dot position indicated by a gray rectangular mark TDP. Further, in FIG. 7, the filter size (applied radius r) of the optimization filter 12 is determined by the following formula (1), which changes depending on the number of ON dots.

r=1+[{(maximum number of selectable dots)−(number of ON dots) }/π]^{1/2} (1)

A weighted distribution of the optimization filter 11 is made such that values obtained by correcting the human visual characteristic (VTF) about the target dot are arranged concentrically. The human visual characteristic may be approximated by the following formula (2), where x and y are coordinates on the matrix when the target dot position is regarded as the origin, f=[πLd(x²+y²)^{1/2}]/(180×25.4), L denotes an observation distance (mm), and d denotes the resolution (dpi).

VTF(x,y)=5.05exp(−0.138f){(1.0−exp(−0.1f)) (2)

In the VTF, the sensitivity rapidly deteriorates for a region of 1 cycle/mm or less (when f<5.0 in the formula (2)), and if reflected as it is to the optimization filter 12, the threshold values may be determined such that the arrangement of the dots is concentrated at one location even for the dot layout in the highlight portion. Accordingly, in the region of 1 cycle/mm or less, the following formula (3) using a regression computation is applied by assuming that the sensitivity of the VTF increases in this region. In this case, it is possible to create a dot pattern which is more suited to the human eye than the dot pattern obtained by the conventional normalized distribution weighting, because the dot pattern is based on the VTF.

VTF(x,y)=1.39408−0.3505×[{d(x²+y²)^{1/2}}/25.4] (3)

As described above, it is undesirable for the dots to be aligned in the vertical and horizontal directions as a result of the optimization process. In order to avoid such an undesirable situation, the weighting in vicinities of 0 degree and 90 degrees, that is, the vertical and horizontal directions, with respect to the target dot, is set to an even larger value.

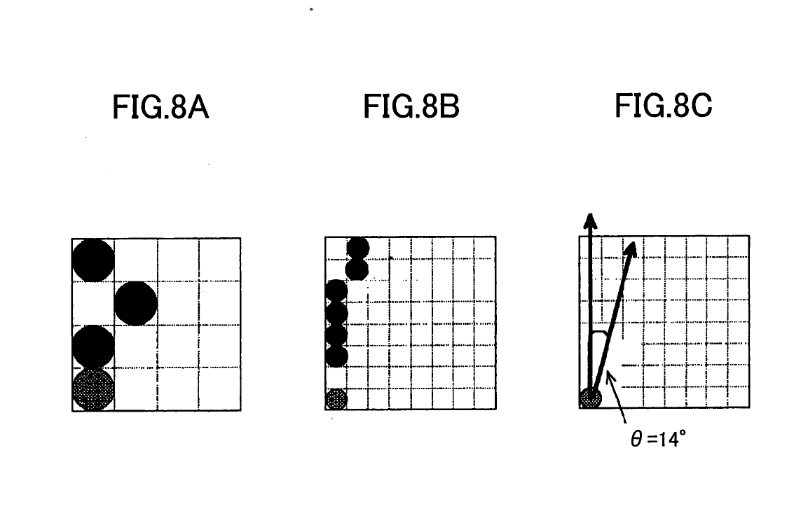

FIGS. 8A, 8B and 8C are diagrams for explaining a relationship of dot alignment and matrix size and an angle of correction. In FIGS. 8A and 8B, the target dot position is indicated by a gray circular mark, and the other dot positions are indicated by black circular marks. As shown in FIG. 8B, even in a case where the dots are arranged at positions deviated by one or two dots from the 0-degree line and the 90-degree line, such an arrangement may also be regarded as an alignment in the vertical and horizontal directions, depending on the size of the threshold value matrix which is created. In order to design a diffusion type threshold value matrix having irregularity (or randomness), it may be regarded that a matrix size of at least 8×8 shown in FIG. 8B or greater is necessary, since a 4×4 matrix size shown in FIG. 8A would essentially be a Bayer type. As shown in FIG. 8C, an angle of view amounting to 2 dots from the 0-degree line and the 90-degree line, that is, a range of ±14 degrees, is treated as the “vicinities” of the vertical and horizontal directions with respect to the target dot position.

In addition, from experimental data, the present inventors found that, if dots arranged or connected in an oblique direction (45 degrees or 135 degrees) are mixed in the pattern in which the dots are randomly scattered, such an arrangement or connection of the dots in the oblique direction become conspicuous to the human eye as texture. Hence, when creating the initial dot layout pattern, a weighted amplification is made not only in the vicinities of the 0-degree and 90-degree directions but also with respect to the 45-degree direction. Although the description given heretofore applies to the first quadrant having the target dot position as the origin, it is of course possible to carry out similar processes with respect to the second, third and fourth quadrants, by appropriately converting the angles depending on the quadrant. In other words, the 0-degree direction may be converted into the 180-degree direction, the 90-degree direction may be converted into the 270-degree direction, and so on.

After optimizing the starting side matrix in the above described manner, the ending side dot layout is determined. First, an initial dot layout pattern similar to that for the starting side is prepared, and an optimization process is carried out after carrying out a process of adjusting to the optimized starting side matrix.

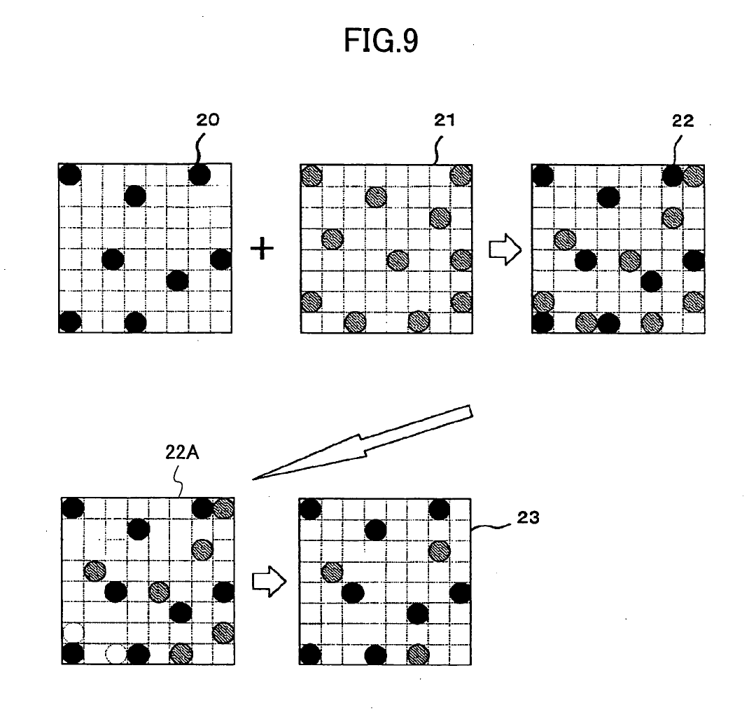

FIG. 9 is a diagram for explaining the adjusting process that is carried out before the optimization process for optimizing the dot layout of the ending side gradation level. First, an ending side initial dot layout pattern 21 (11 ON dots) and an optimized starting side dot layout pattern 20 (8 ON dots) are combined. In a combined dot layout pattern 22 (10 ON dots, 5 surplus dots), the optimization method described above is applied to the dots other than the starting side dots, so as to delete surplus dots one dot at a time as indicated by a pattern 22A, and an ending side initial dot layout pattern 23 (11 ON dots) which is adjusted to the starting side is created. Finally, the optimization described above is carried out with respect to the dots other than the starting side dots in the ending side initial dot layout pattern 23 after the adjusting process, so as to determine the optimum ending side dot layout.

The purpose for adjusting the ending side to the starting side is as follows. That is, although it is possible to prepare threshold value matrixes having different dot layouts for each of the gradation levels, the continuity of the gradation levels will be lost. Such a loss of continuity may generate pseudo contour or texture. Furthermore, in inexpensive image forming apparatuses, it is difficult, costwise, to provide a large number of threshold value matrixes. Therefore, by constantly adjusting the starting side and the ending side to match the layout, it becomes possible to incorporate all gradations which are finally representable within one dot layout of the threshold matrix.

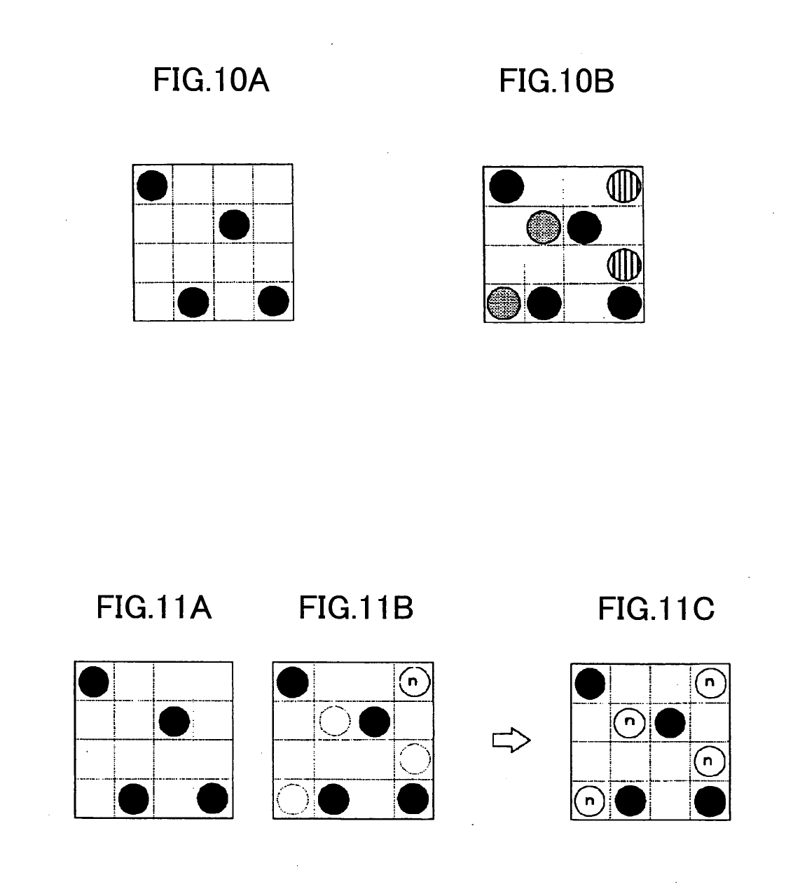

FIGS. 10A and 10B are diagrams for explaining the optimized dot layouts for the starting side and ending side gradation levels which are obtained by the above described process. FIG. 10A shows an optimizing m mask for the starting side, and FIG. 10B shows the optimizing n mask for the ending side. In FIGS. 10A and 10B, a black circular mark indicates the dot existing at the same position as the m mask from the start, a gray circular mark indicates the dot which does not exist in the n mask but is arranged by the adjustment to the m mask, and a circular mark with vertical stripes indicates the dot which is arranged as a result of the optimization carried out after the adjustment to the m mask.

Actually, the steps S1 through S3 shown in FIG. 2 are repeated a number of times as required, from the highlight side towards the shadow side. For example, if the starting side gradation level m and the ending side gradation level n are picked up the first time, the previous ending side gradation level n is newly picked up as the starting side gradation level and a gradation level which is a predetermined number of levels closer to the shadow side is newly picked up as the ending side gradation level the second time. The optimized dot layout of the starting side gradation level is used as it is, and an adjusting process is carried out on the initial dot layout patter of the ending side gradation level with respect to the starting side dot layout. An optimization is carried out thereafter to determine the ending side dot layout.

When the dot layout of the random gradation levels is determined as described above, the step S4 shown in FIG. 2 determines the dot layout of each gradation level between two random gradation levels, as shown in FIGS. 11A, 11B and 11C. FIGS. 11A, 11B and 11C are diagrams for explaining optimization of dot positions at gradation levels between the starting side and ending side gradation levels. FIG. 11A shows the optimizing m mask, FIG. 11B shows the m+1 mask, and FIG. 11C shows the optimizing n mask. In FIGS. 11A through 11C, a black circular mark indicates the dot existing at the same position as the m mask from the start, a circular mark indicated by a dotted line indicates a selectable dot position (candidates), and a circular mark marked “n” indicates the dot which is added by an increase of one level of the gradation level.

In the gradation level m+1 next to the gradation level m which is picked up, the candidate position of the dot to be added is selected down to one of the dots in the dot layout of the end side gradation level n. The position of the dot to be added is selected from the dot candidate positions indicated by the circular marks indicated by the dotted line in FIG. 11B using the optimization method described above. As a result, the dot layout of the gradation level m+1 is determined, and the dot layout of the next gradation level m+2 is determined similarly, by assuming this time that the gradation level m+1 is the starting side gradation level. The dot layout of all of the gradation levels between the two picked up gradation levels (starting side and ending side gradation levels m and n) are determined in a similar manner.

Of course, after the dot layout of a pair of starting side and ending side gradation levels are determined, it is possible to employ a processing procedure which immediately determines the dot layout of the gradation level between the starting side and ending side gradation levels.

When the dot layout of all of the gradation levels is determined in the above described matter, the appearing order of the dots from the highlight side to the shadow side is determined. Hence, the step S5 creates the layout (threshold value layout order) of the diffusion type threshold value matrix for representing the halftone by the ON and OFF states of one kind of dot, that is, by a bi-level data. The created layout is used as the basic layout 1 shown in FIG. 3. As described above in relation to the initial dot layout pattern, it may be more preferable to use the existing dither having the regularity in the highlight portion, depending on the resolution (particularly for the low resolution), and in this case, the entire gradation section of the highlight side may be replaced by the existing dither.

Next, a description will be given of the steps S6 and S7 shown in FIG. 2. The steps S6 and S7 carry out a process to create a threshold value matrix for representing the halftone by the ON and OFF states of two or more kinds of dots, that is, by a three or more valued data. As described above, this type of halftone representation method may control the dot diameter, the ink tone, or both the dot diameter and ink tone. But in this embodiment, it is assumed for the sake of convenience that the dot diameter is controlled.

First, the step S6 computes a gradation reproducible range for each quantization level. Then, the step S7 allocates each of the computed gradation reproducible ranges to the basic layout, so as to create a threshold value matrix for each quantization level. The basic layouts of the threshold matrixes corresponding to each of the dot diameters are the same and common to each other, but the individual threshold values and threshold value differences in the layout are determined by a difference with respect to a 100% non-segmented tone that can be formed by the corresponding dot diameter and the matrix size. As a result, the representable tone width differs depending on the dot diameter even for the same dot area, but the tone change per single gradation level can be maintained constant for all of the dot diameters.

FIG. 3 shows the threshold value matrixes 2, 3 and 4 for representing the halftone by four-valued data using small, medium and large dots, respectively, and the basic layout 1which is applied in common to these threshold value matrixes 2, 3 and 4. Since the basic layout 1 is the layout of the bi-level optimized diffusion type threshold value matrix, each of the threshold value matrixes 2, 3 and 4 are also diffusion type threshold value matrixes.

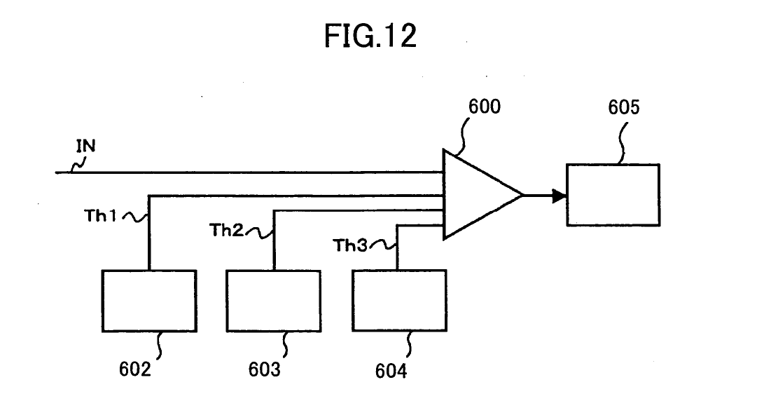

FIG. 12 is a system block diagram showing an image forming apparatus which represents halftone by four-valued data using the threshold value matrixes 2, 3 and 4. In FIG. 12, a quantization unit 600 quantizes a multi-level image data IN into four-valued data using three quantization threshold values Th1, Th2 and Th3 from threshold value generators 602, 603 and 604. The threshold value generators 602, 603 and 604 generate the threshold values of the threshold value matrixes 2, 3 and 4 corresponding to each of the pixels of the multi-level image data IN in the image space, and outputs the generated threshold values as the three quantization threshold values Th1, Th2 and Th3. Each of the threshold value generators 602, 603 and 604 may be formed by a memory such as a ROM which stores the corresponding one of the threshold value matrixes 2, 3 and 4, and a counter which reads the threshold values from the ROM in response to a pixel clock of the multi-level image data IN. Of course, the threshold value generators 602, 603 and 604 may be formed by a single ASIC circuit.

The quantization unit 600 outputs to an image forming engine 605 a quantized signal which indicates the OFF state of the dot if the pixel value of the multi-level image data IN is less than the quantization threshold value Th1, indicates the ON state of the small dot if the pixel value is greater than or equal to the quantization threshold value Th1 and is less than the quantization threshold value Th2, indicates the ON state of the medium dot if the pixel value is greater than or equal to the quantization threshold value Th2 and is less than the quantization threshold value Th3, and indicates the ON state of the large dot if the pixel value is greater than or equal to the quantization threshold value. The image forming engine 605 forms an image which represents the halftone by four-valued data, by controlling the ON and OFFG states of the large, medium and small dots depending on the quantized signal received from the quantization unit 600.

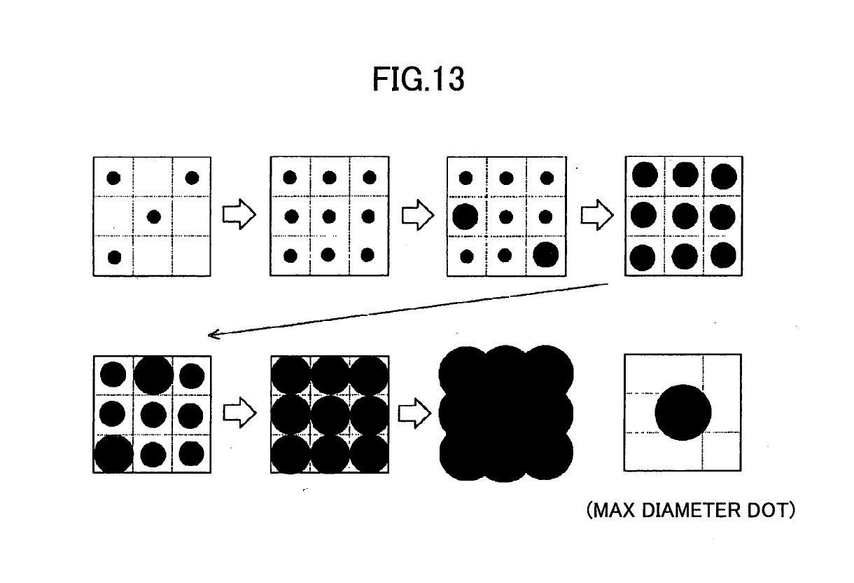

In an image forming apparatus which is capable of realizing an extremely fine control of the dot diameter, it is possible to obtain a sufficient gradation representation using only the area modulation, without having to use the diffusion characteristic. However, in the inexpensive image forming apparatuses which are popularly used, such as the ink-jet printer, the electrophotography type printer and the thermal transfer printer, it is only possible to make a dot diameter modulation on the order of two to three stages. For this reason, in order to realize a smooth gradation representation in such inexpensive image forming apparatuses, it is essential to use the diffusion characteristic. In addition, because the dot diameters that can be modulated differ considerably depending on the image forming apparatus, a dot switching such as that shown in FIG. 13 is required. FIG. 13 is a diagram for explaining a dot switching method which is employed when making a gradation representation using large, medium and small dots. Unless the dot switching is made, the dot having the maximum diameter may be printed fist depending on the layout of the threshold value matrix, and the advantage of forming the image using three or more valued data may be lost as a result of the image formation being made comparably to the case where the bi-level data is used.

In the case where the bi-level data is used, it is necessary to form a non-segmented image by dots having a fixed dot diameter, and thus, the dot diameter is normally set to √2 or more times the resolution pitch. As a result, partially overlapping dots are generated in the actual image before the dot area coverage in the data reaches 50%. If the level does not change by the overlap as in the case of the digital data and the level “1” remains to be “1” even when the overlap occurs, it is possible to reflect the overlap to the threshold value by simply subtracting the overlapping area. However, this simple approach cannot be used in actual practice.

For example, in the case of the ink-jet printer, more ink is adhered on the overlapping portion to increase the tone. In the case of the electrophotography type printer or the thermal transfer printer, more recording energy (charge or heat) is concentrated at the overlapping portion, and unwanted dot gain is generated as the concentrated recording energy is transferred to the portions surrounding the overlapping portion.

In the case where the three or more valued data is used, a similar problem does occur with the dot having the maximum size. However, the problem can be avoided by making the dot switching shown in FIG. 12, expect for an extremely limited shadow portion. On the other hand, for the dots having sizes other than the maximum size, no overlapping portion is generated even when the dot area coverage is set to 100%, and it is possible to compute the number of gradation levels representable by the dots having the various sizes, by simply using the area coverage, the Yule-Nielsen polynomial or the like. As described above, by arranging the number of gradation levels according to the layout of the diffusion type threshold value matrix, it is possible to create a diffusion type threshold value matrix corresponding to each dot size.

In addition, depending on the dot size, the representable number of gradation levels does not necessarily become the same for each dot size, but the layout of the threshold values are the same. Hence, even if the dot layout pattern for each gradation level differs for each dot size, no unnaturalness occurs when the dot layout patterns are combined. Furthermore, it is possible to reduce the size of the threshold value matrix while maintaining the picture quality, because the number of gradation levels can be divided for each dot size and the granularity can be improved by reducing the dot diameter even for the same layout. Consequently, the time and load required to develop the threshold value matrixes can be reduced, and it is possible to reduce the cost of providing the threshold value matrixes in the image forming apparatus.

The threshold value matrix created by the present invention is applicable to any image recording system which represents images by dots. The threshold value matrix created by the present invention is particularly suited for application inexpensive printers, such as the ink-jet printers, electrophotography type printers and thermal transfer printers, which record multi-level image data but cannot finely control the dot diameter and the dot tone over a wide range.

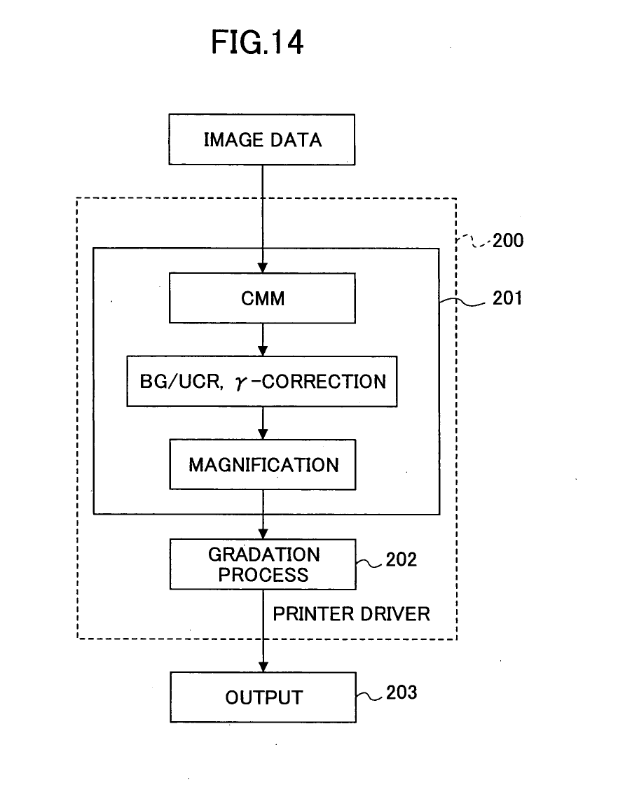

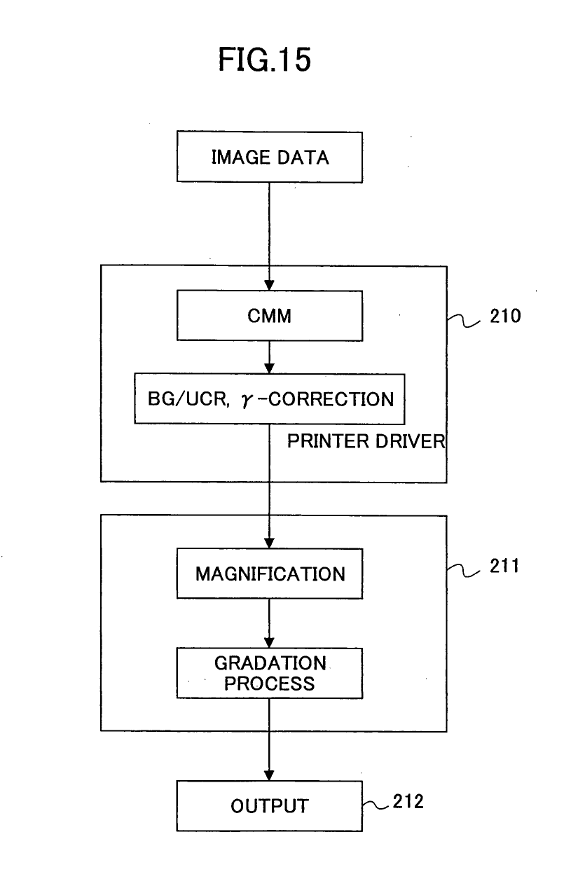

Next, a description will be given of embodiments of the image output system according to the present invention, which use the threshold value matrix created in the above described manner, by referring to FIGS. 14 and 15.

FIG. 14 is a diagram showing the structure of an embodiment of the image output system according to the present invention. A printer driver 200 shown in FIG. 13 is executed by a personal computer, for example, and includes a pre-processing module 201, and a gradation processing module 202 which is provided with the threshold value matrixes which are created according to the present invention. The pre-processing module 201 carries out a generally known pre-processing, including color management module (CMM), black generate/under color reduction (BG/UCR) and γ-correction, and magnification, with respect to the image data. The gradation processing module 202 quantizes the image data which has been subjected to the pre-processing in the pre-processing module 201 into halftone data made up of three or more valued data, using the threshold value matrixes described above. The halftone data output from the gradation processing module 202 is supplied to a printer 203 which prints the halftone image on a recording medium such as paper. This structure shown in FIG. 14 is particularly suited for application to inexpensive printers.

FIG. 15 is a diagram showing the structure of another embodiment of the image output system according to the present invention. A printer drive 210 shown in FIG. 15 is executed by a personal computer, for example. The printer driver 210 carries out a generally known pre-processing, including CMM, and BG/UCR and γ-correction, with respect to the image data. A controller 211 is provided in the printer, and carries out a generally known pre-processing including magnification with respect to the image data. The controller 211 also carries out a gradation processing to quantize the image data which has been subjected to the above pre-processing into halftone data made up of three or more valued data, using the threshold value matrixes described above. The halftone data output from the controller 211 is supplied to an image forming engine 203 of the printer which prints the halftone image on a recording medium such as paper. This structure shown in FIG. 15 is particularly suited for application to high-speed printers.

The quantizing means of the controller 211, which carries out the gradation processing, may be realized by a combination circuit or an ASIC circuit having the structure shown in FIG. 12, for example, but it is also possible to realize this quantizing means by a microprocessor.

Of course, the printers referred above may be included in image forming apparatuses, such as copying machines including digital copying machines, facsimile machines, and composite apparatuses which have composite functions of a plurality of apparatuses such as printers, copying machines and facsimile machines.

Next, a description will be given of the picture quality deterioration which occurs at a low resolution and/or during a high-speed recording in an image forming apparatus.

In the conventional image forming apparatuses (or image recording apparatuses) such as the printers, facsimile machines and copying machines, the digital image data which is formed is a bi-level image made up of “1”s and “0”s or, dots having ON and OFF states. But due to progresses made in the image forming engine and the demand for realizing a high quality image, it is becoming more popular to form multi-level image data which represents each pixel in a plurality of gradation levels.

For example, in the ink-jet printer, the tone modulation method which changes the tone of the ink, the dot size modulation method which uses dots having different sizes, and a method which uses both the tone modulation method and the dot size modulation method are most commonly used at the present.

A pressure generating means of an ink-jet head is formed by a heating resistor which generates air bubbles in the case of the thermal ink-jet, a piezoelectric element in the case of the piezoelectric ink-jet, and an electrostatic element in the case of the electrostatic ink-jet. The dot size is controlled by controlling an amplitude, a pulse width, a number of pulses and the like of a driving voltage which is applied to electrodes of such pressure generating means. However, due to the spreading of the ink and the like, the dot size control can realize only four states at the most with a satisfactory reproducibility, namely, a large dot, a medium dot, a small dot and no dot.

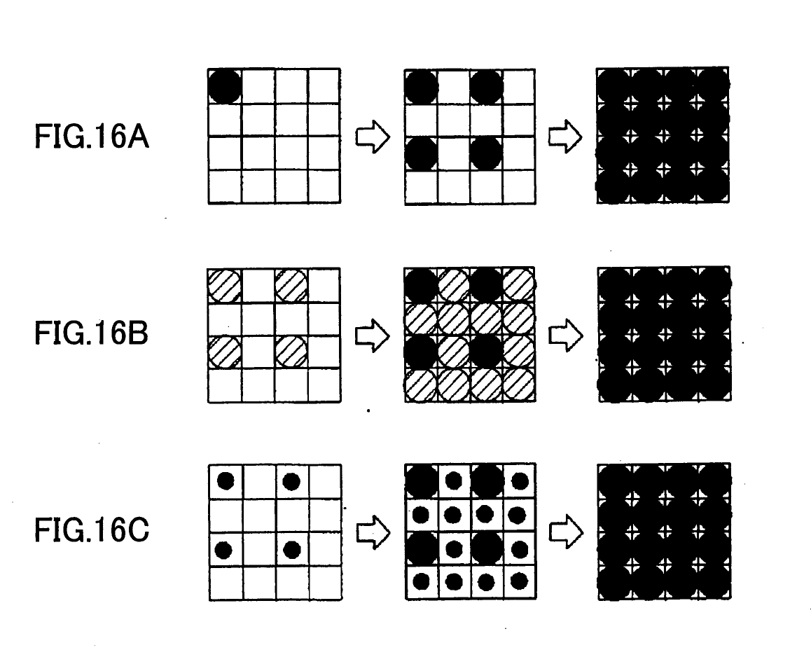

FIGS. 16A through 16C are diagrams for explaining dot layout patterns which are used when carrying out the general binarization process and multi-level process. FIG. 16A shows the dot reproduction for a case where the binarization process is carried out, FIG. 16B shows the dot reproduction for a case where the tone modulation is carried out, and FIG. 16C shows the dot reproduction for a case where the dot size modulation is carried out. In FIGS. 16A through 16C, black circular marks indicate the dots, and circular marks with hatching indicate dots having a lower tone than the dots indicated by the black circular marks. Further, in FIGS. 16A through 16C, the dot pattern on the left indicates a low (light) tone, the dot pattern in the middle indicates a medium tone, and the dot pattern on the right indicates a high (dark or maximum) tone.

According to the dot reproduction shown in FIGS. 16A through 16C, the amount of information is basically determined by the controllable dot size. The amount of information increases as the number of controllable dot sizes increases, to thereby enable reproduction of a high-quality picture close to the original image data. But as described above, the number of controllable dot sizes is only on the order of one to three (or four when 0 is included) in the case of most ink-jet printers. It is possible to improve the picture quality to a certain extent by combining the dot size modulation method and the tone modulation method, but the load is then put on the coloring agents (dyes) and recording units in order to achieve the desired picture quality. Consequently, due to cost and size restrictions on the image forming apparatus, it is only possible to improve the picture quality to two times at the most, even when the dot size modulation method and the tone modulation method are combined.

In order to compensate for the insufficient amount of information per pixel, a pseudo gradation representation which is generally referred to as a halftone process is used as a technique for controlling the number of dots per unit area. The pseudo gradation representation represents the number of dots which are arranged as a tone, and represents a large number of gradation levels by changing the density of the dot.

The dither method is popularly used for the pseudo gradation representation, and typical dither methods are the systematic dither method and the random dither method. The systematic dither method sets a sub matrix (or dither matrix) made up of n×n threshold values, and overlaps this dither matrix with the input image to compare the tone level of each pixel and the corresponding threshold value in the dither matrix. A bi-level representation is made by setting a value “1” (black) if the pixel value of the input image is greater than or equal to the corresponding threshold value, and setting a value “0” (white) if the pixel value of the input image is less than the corresponding threshold value. If the processing of n×n pixels ends, the image is formed by repeatedly carrying out the above described process while successively moving the dither matrix to the position of the next n×n pixels.

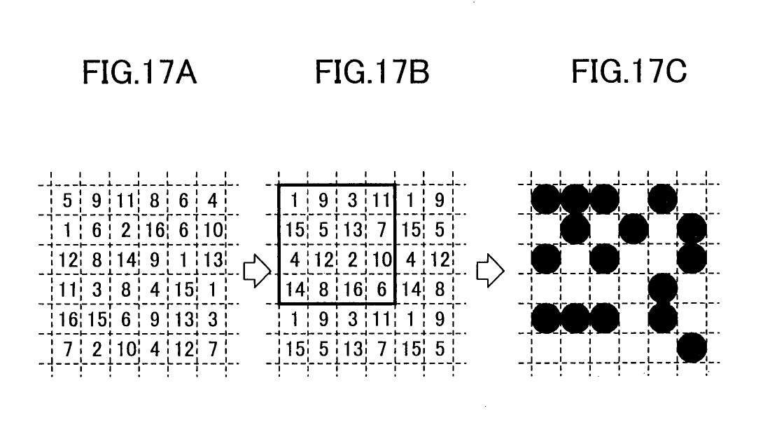

FIGS. 17A, 17B and 17C are diagrams for explaining the systematic dither method. For example, with respect to an input multi-level image data shown in FIG. 17A, a comparison is made with an n×n dither matrix shown in FIG. 17B which is created by a predetermined method. Hence, only the pixels of the input image having values greater than or equal to the corresponding threshold values are replaced by dots as shown in FIG. 17C. Of course, it is possible to replace only the pixels of the input image having values less than the corresponding threshold values by the dots.

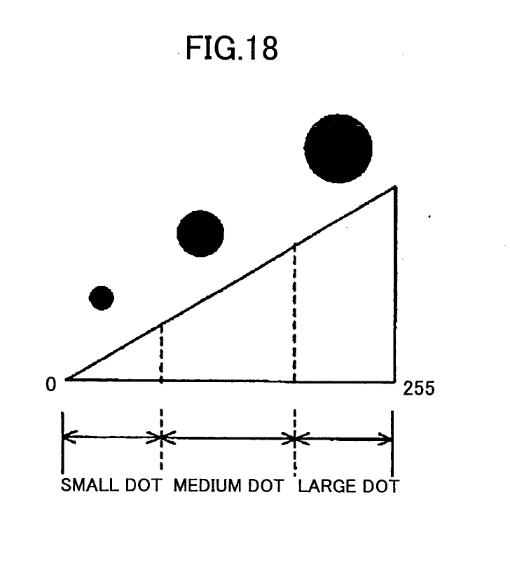

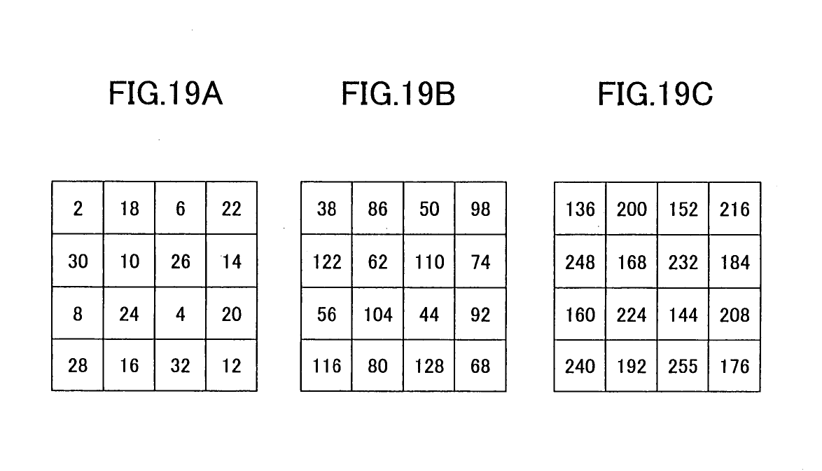

FIG. 17C shows a case where the dots are bi-level, that is, the dots have an ON state or an OFF state. However, the dots may be made to have multi-levels by sectioning the reproducible gradation region into small, medium and large dots as shown in FIG. 18. FIG. 18 is a diagram showing a correspondence between size modulated dots and dither mask. In this case, a threshold value matrix corresponding to the dot size is used for each of the small, medium and large dots, when making the comparison with the input image data to make the replacement to the dots. FIGS. 19A, 19B and 19C are diagrams respectively showing the threshold value matrixes for the small, medium and large dots.

On the other hand, the random dither method generates a random value with respect to each pixel of the input image and uses the generated value as the threshold value. However, the image formed using the random dither method is not very smooth in general, and is unsuited for improving the picture quality as compared to the systematic dither method.

Furthermore, the pseudo gradation representation may be made by the error diffusion method. However, the error diffusion method requires a considerably complex process when compared to the dither methods.

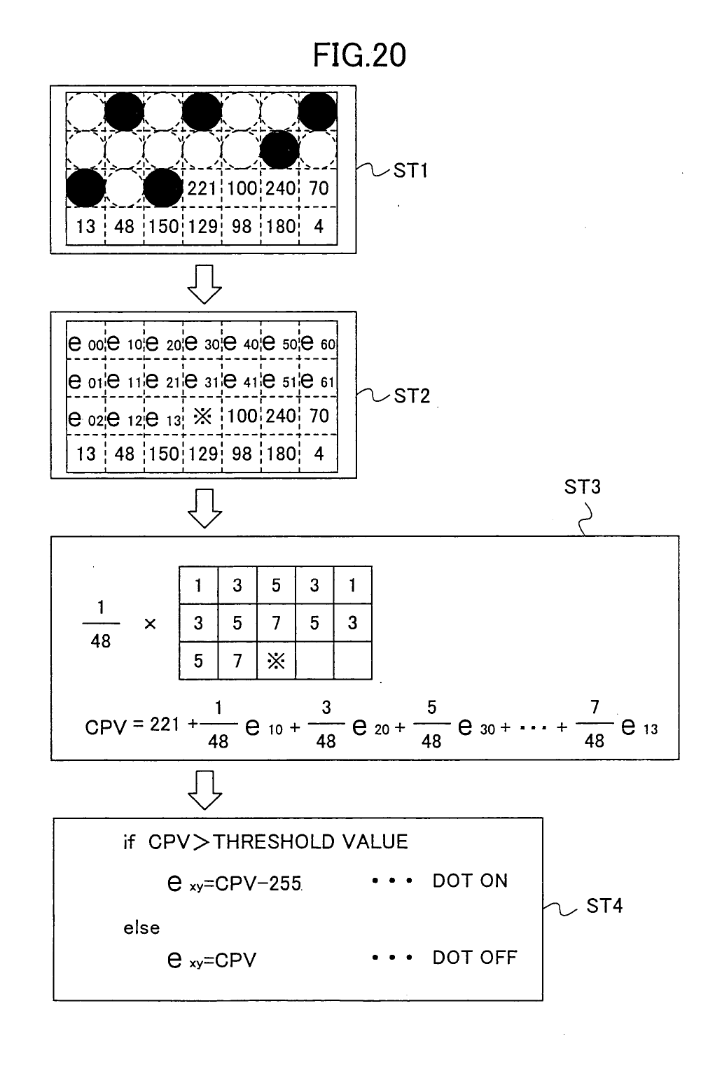

FIG. 20 is a diagram for explaining a bi-level error diffusion technique. In FIG. 20, a step ST1 carries out an error diffusion process shown. Black circular marks indicate the pixels having the dots which are ON, circular marks indicated by a dotted line indicate pixels having the dots which are OFF, and numerals indicate the pixels which are not yet processed. A step ST2 carries out a threshold value process shown. e_{xy} denotes an error generated by the threshold value process, and [symbol] indicates a target pixel which is the target of the next error diffusion process.

A step ST3 multiplies an error weight matrix EWM to the error values of the processed peripheral pixels, and calculates a corrected pixel value CPV by adding the error weight matrix EWM to the value of the next processing target pixel. [symbol] indicates the target pixel which is the target of the next error diffusion process. A step ST4 compares a fixed (or variable) threshold value and the corrected pixel value CPV, and calculates the ON and OFF states of the dots and the error value (e_{xy}), where non-segmented image is indicated by “255” and solid color is indicated by “0”.

Hence, the error diffusion method carries out the threshold value process for each pixel and holds the error while reflecting the error to the latter calculations at a predetermined ratio. Hence, the error diffusion method can feed back to the output image even the amount of information which is forcibly discarded in the dither process, thereby making it possible to obtain a picture quality which is improved over the dither image from the point of view of the resolution and the like.

Developments are being made to further improve the resolution while obtaining a high picture quality by the dither methods and error diffusion method described above. This is because the individual dot size and separation of the dots become small as the resolution becomes high, and the dot patterns created by the dither method or the error diffusion method become more difficult recognize. If the dot pattern is not recognizable by the human eye, this is equivalent to making a multi-level representation by one pixel. In ink-jet printers which have been recently developed, a resolution of 2880 dpi has been realized.

Although the picture quality is improved by improving the resolution, the cost of the recording unit increases and the recording (printing) speed decreases. In order to realize the high resolution, a high-precision control is required to maintain the high dot position accuracy, in addition to the requirement to form dots which are smaller than the conventionally used dots. As a result, the cost of the image forming apparatus inevitably becomes high. In addition, when using the same recording unit, it takes more time to make the recording for the higher resolution because the coverage area per dot becomes smaller for the higher resolution.

But in actual practice, there are cases where a high picture quality is preferred over the recording speed and cost, and also cases where the desired recording speed and cost are preferred as long as a picture quality higher than a predetermined quality is obtainable. In other words, it is not always the case that the high picture quality is required.

But up to now, all emphasis was put on further improving the dot forming speed and further improving the mounting density of the recording units by means of hardware, while maintaining the high resolution. In other words, the emphasis was put on increasing the recording speed of the image forming apparatuses which are designed for the high picture quality, and not on improving the picture quality of the inexpensive image forming apparatuses which have low resolutions.

When increasing the recording speed of the image forming apparatus which is designed for the high picture quality, it is impossible to realize considerable improvement in the recording speed unless the recording sequence itself is modified, because of the cost restrictions and restrictions on the mounting area. In addition, when the recording sequence is modified, it is impossible to apply the image processing for the high resolution unless the image processing itself is also modified. As a result, it is necessary to modify the image processing depending on the modified recording sequence. But in the conventional image forming apparatuses, only a simple image processing is applied, and no attempts were made to positively improve the picture quality.

Next, a description will be given of embodiment of a gradation reproducing method, threshold value matrix, image processing method, image processing apparatus, image forming apparatus and printer driver according to the present invention, which can obtain a satisfactory picture quality even at a low resolution and/or during a high-speed recording.

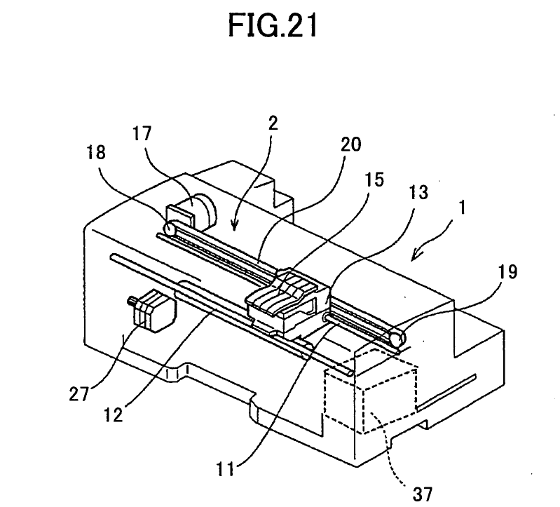

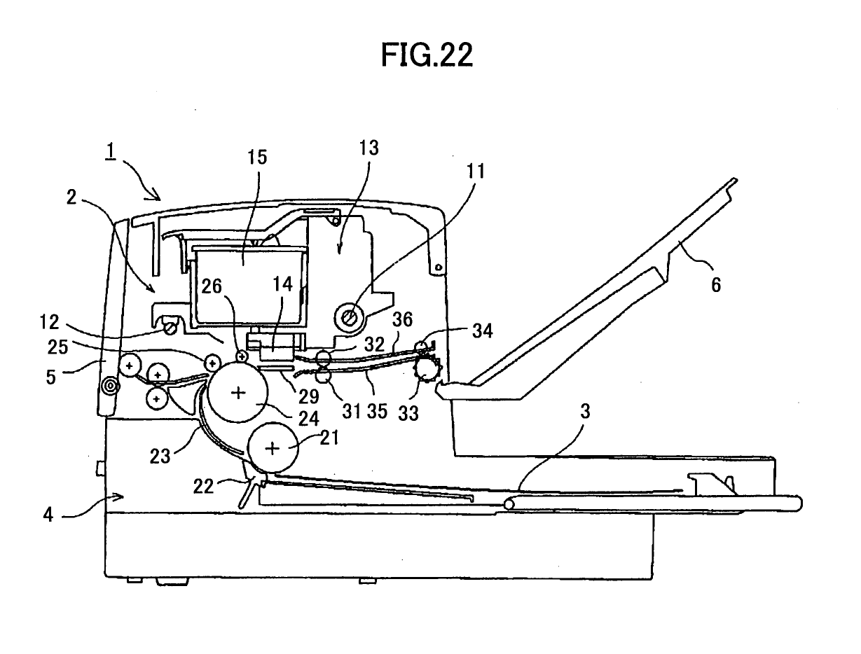

FIG. 21 is a perspective view showing a structure of a first embodiment of the image forming apparatus according to the present invention, and FIG. 22 is a side view showing the structure of the first embodiment of the image forming apparatus. For the sake of convenience, FIGS. 21 and 22 show important internal parts of the image forming apparatus although actually not visible in the perspective and side views. In this first embodiment of the image forming apparatus, the present invention is applied to an ink-jet printer.

In the ink-jet printer shown in FIGS. 21 and 22, a printing mechanism 2 is provided within a main printer body 1. The printing mechanism 2 includes a carriage 13 which is movable in a main scanning direction, recording heads 14 mounted on the carriage 13, and ink cartridges 15 for supplying inks to the recording heads 14. Paper 3 is supplied from a paper supply cassette 4 or a manual paper feed tray 5, and the printing mechanism 2 records an image on the paper 3. The paper 3 recorded with the image is ejected to a paper eject tray 6 which is located on a rear side of the main printer body 1.

In the printing mechanism 2, the carriage 13 is slidably supported by a main guide rod 11 and a sub guide rod 12 so as to be movable in the main scanning direction (in a direction perpendicular to the paper in FIG. 22). The main and sub guide rods 11 and 12 are provided between right and left side plates of the main printer body 1. The recording heads 14 are made up of ink-jet heads for respectively ejecting yellow (Y), cyan (C), magenta (M) and black (Bk) inks in a downward direction. The ink cartridges (ink tanks) 15 for supplying the yellow (Y), cyan (C), magenta (M) and black (Bk) inks to the corresponding ink-jet heads is detachably mounted on top of the carriage 13.

Each ink cartridge 15 has an upper opening which opens to the atmosphere, a lower opening for supplying the ink to the corresponding ink-jet head, and a porous material which is provided inside to hold the ink. The ink within the ink cartridge 15 is maintained to a slightly negative pressure by the capillary force of the porous material. The ink is supplied to the ink cartridge 15 to the corresponding ink-jet head.

The rear side (downstream side along the paper transport direction) of the carriage 13 is slidably supported by the main guide rod 11, and the front side (upstream side along the paper transport direction) of the carriage 13 is slidably supported by the sub guide rod 12. In order to move the carriage 13 in the main scanning direction, a timing belt 20 is between a driving pulley 18 which is driven by a motor 17 and a following pulley 19, and this timing belt 20 is fixed to the carriage 13. Hence, the carriage 13 makes a reciprocal movement as the motor 17 is rotated in the forward and reverse directions.

The recording heads 14 are made up of the ink-jet heads which eject the yellow (Y), cyan (C), magenta (M) and black (Bk) inks in this embodiment. However, it is possible to use a single recording head which ejects the yellow (Y), cyan (C), magenta (M) and black (Bk) inks. As will be described later, it is possible to use for the recording head 14 a piezoelectric type ink-jet head which includes a vibration plate forming at least a portion of a wall of an ink passage, and a piezoelectric element which deforms this vibration plate to apply pressure on the ink.

Of course, the structure of the recording head 14 is not limited to the above. For example, it is possible to use an electrostatic type ink-jet head having a vibration plate forming at least a portion of the wall of the ink passage, and an electrode confronting the vibration plate, where the vibration plate is deformed by electrostatic force to apply pressure on the ink. In addition, it is possible to use a thermal type ink-jet head which generates air bubbles by heating the ink within the ink passage using a heating resistor, so as to apply pressure on the ink by the air bubbles.

On the other hand, in order to transport the paper 3 which is set in the paper supply cassette 4 under the recording head 14, the following mechanisms are provided. That is, a paper supply roller 21 and a friction pad 22 are provided to separate and supply each paper 3 from the paper supply cassette 4 towards a paper guide member 23. A transport roller 24 turns over the side of the paper 3. A transport roller 25 pushes against the peripheral surface of the transport roller 24. A tip end roller 26 restricts a feed angle of the paper 3 from the transport roller 24. The transport roller 24 is driven by a motor 27 via a gear mechanism.

A paper guide member 29 guides the paper 3 which is fed from the transport roller 24 in correspondence with the moving range of the carriage 13 in the main scanning direction, under the recording heads 14. A transport roller 31 which is driven to feed the paper 3 in the paper eject direction, is provided at a position confronting a roller 32, on the downstream side of the paper guide member 29 along the paper transport direction. Further, a paper eject roller and a roller 34 are provided to eject the paper 3 onto the paper eject tray 6, and guide members 35 and 36 are arranged to form a paper eject path.

At the time of the recording, the recording heads 14 are driven in response to an image signal while moving the carriage 13, so as to eject the inks onto the stationary paper 3 and record one line. The next line is recorded after transporting the paper 3 by a predetermined amount in the paper transport direction. The recording operation is ended and the paper 3 is ejected in response to a recording end signal or a signal which indicates that a rear end of the paper 3 has reached the recording region of the recording heads 14.

A recovery unit 37 is arranged at a position on the right side in the moving direction of the carriage 13, outside the recording region. The recovery unit 7 includes a cap means, a suction means and a cleaning means, for recovering the recording heads 14 from a state where the ink-ejection is deteriorated or unsatisfactory. The carriage 13 is moved to the position of the recovery unit 37 during a recording wait state, so that the recording heads 14 are capped by the capping means to prevent the ink ejection nozzles of the recording heads 14 from drying and clogging. In addition, when a purge operation is carried out with respect to the ink which is not related to the recording during the recording or the like, the suction means sucks the ink from the ink ejection nozzle of the corresponding recording head 14 and cleans the ink ejection nozzles by the cleaning means, so that the ink viscosity is maintained the same at each of the ink ejection nozzles to maintain a stable ink-jet performance.

When the ink-jet deteriorates, for example, the suction means sucks the ink, air bubbles and the like from the ink-jet nozzles in a state where the ink-jet nozzles are sealed by the capping means. As a result, the cleaning means can remove the ink, dust particles and the like adhered in the vicinity of the ink-jet nozzles, to positively recover the ink-jet performance of the recording heads 14. The inks recovered by the recovery unit 37 are drained to an ink drain tank (not shown) located at the lower portion of the main printer body 1, and is absorbed by an ink absorbing material provided within the ink drain tank.

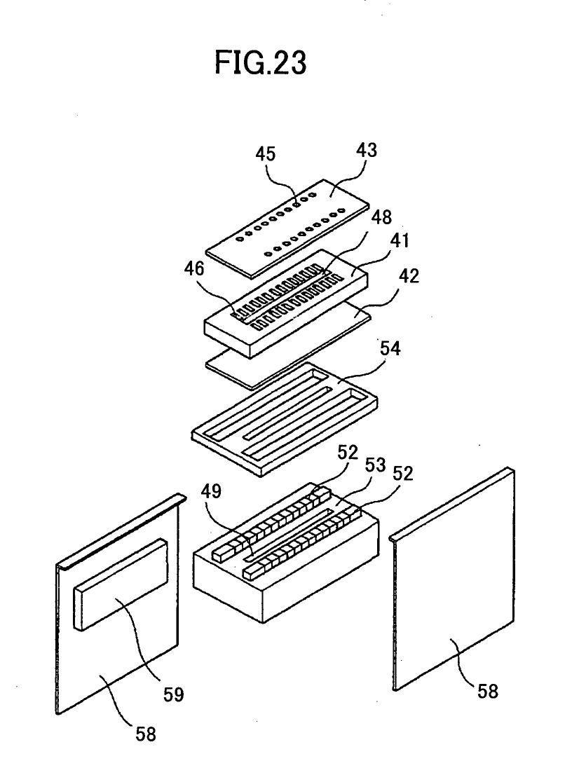

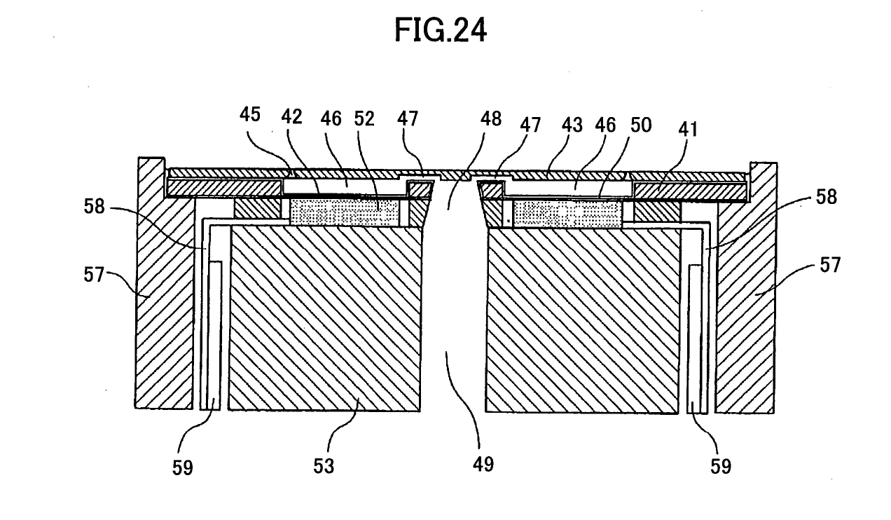

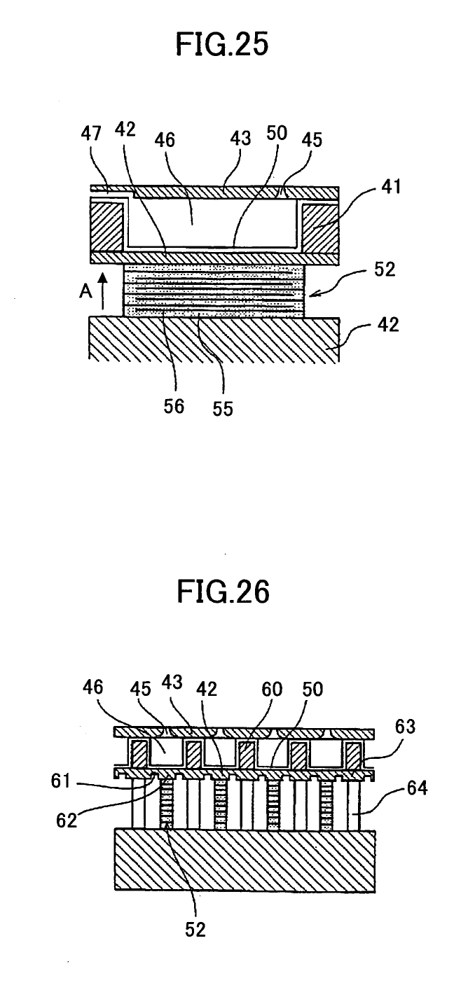

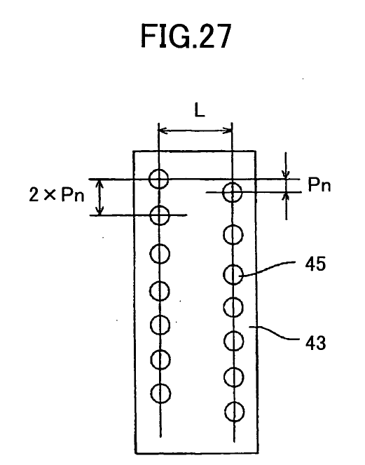

Next, a description will be given of the recording head 14 of the ink-jet printer, by referring to FIGS. 23 through 27. FIG. 23 is a disassembled perspective view of the recording head. FIG. 24 is a cross sectional view of the recording head along a longitudinal direction of an ink chamber, and FIG. 25 is an enlarged view showing an important part of FIG. 24. FIG. 26 is a cross sectional view of the recording head along a shorter side of the ink chamber. Further, FIG. 27 is a plan view showing a nozzle plate of the recording head.

The recording head 14, that is, the ink-jet head, includes a flow passage forming substrate (low passage forming member) 41 made of a single crystal silicon substrate, a vibration plate 42 bonded to a lower surface of the flow passage forming substrate 41, and a nozzle plate 43 bonded to an upper surface of the flow passage forming substrate 41. Ink-jet nozzles 45 for ejecting the ink are formed in the nozzle plate 43. The ink-jet nozzles 45 communicate to pressure chambers 46 which form ink flow passages. A common ink chamber 48 supplies the ink to the ink chambers 46 via an ink supply passage 47 which functions as a flow passage resistance portion. A ink resistant thin film 50 made of an organic resin is formed on each wall of the pressure chambers 46, the ink supply passage 47 and the common ink chamber 48 which contact the ink on the flow passage forming substrate 41.

A stacked type piezoelectric element 52 is provided in correspondence with each pressure chamber 46 on the outer surface side (surface side opposite to the common ink chamber 48). In addition, the piezoelectric element 52 is fixed on a base substrate 53. A spacer member 54 is provided around the rows of piezoelectric elements 52.

As shown in FIG. 25, the piezoelectric element 52 has a stacked structure alternately having a piezoelectric material 55 and an internal electrode 56. The corresponding pressure chamber 46 is made to expand and contract due to contraction and expansion of the piezoelectric element 52 having a piezoelectric constant of d33. When a driving signal is applied to the piezoelectric element 52 and a charging is carried out, an expansion takes place in a direction indicated by an arrow A in FIG. 25. On the other hand, when the charge which is charged in the piezoelectric element 52 is discharged, a contraction takes place in a direction opposite to the direction indicated by the arrow A. The base substrate 53 and the spacer member 54 have penetrating holes which form an ink supply opening 49 for supplying the ink from the outside to the common ink chamber 48.

A head frame 57 is formed from an epoxy resin of polyphenylene sulfite by ejection molding. The outer peripheral portion of the flow passage forming substrate 41 and the lower outer edge portion of the vibration plate 42 are bonded to the head frame 57. The head frame 57 and the base substrate 53 are fixed to each other at a portion (not shown) by use of an adhesive agent, for example. A flexible printed circuit (FPC) cable 58 for supplying a driving signal is connected to the piezoelectric elements 52 by soldering, anisotropic conductor film (ACF) or wiring-bonding. A driving circuit (driver IC) 59 for selectively applying the driving signal (driving waveform) to each piezoelectric element 52 is connected to the FPC cable 58.

A (110) crystal face of the single crystal silicon forming the flow passage forming substrate 51 may be subjected to an anisotropic etching using an alkaline etchant such as a potassium hydroxide (KOH) solution, so as to form the penetrating holes which become the pressure chambers 56, a groove portion which becomes the ink supply passage 57, and the penetrating hole which becomes the common ink chamber 58.

As shown in FIG. 26, the vibration plate 42 is made of a metal, such as nickel, by electro-forming. The vibration plate 42 has thin portions 61 corresponding to each pressure chamber 46 so as to facilitate deformation of the vibration plate 42, thick portions 62 which are bonded to the piezoelectric elements 52, and thick portions 63 corresponding to partitioning walls between the pressure chambers 46. The flat surface side of the vibration plate 42 is bonded to the flow passage forming substrate 41 by an adhesive agent, and the thick portions 62 and 63 of the vibration plate 42 are bonded to the head frame 57 by an adhesive agent. Column portions 64 are provided between the base substrate 53 and the corresponding thick portions 63 of the vibration plate 42. The column portions 64 have the same structure as the piezoelectric elements 52.

The nozzle plate 43 includes the ink-jet nozzles 45 having a diameter of approximately 10 μm to 30 μm, at positions corresponding to the pressure chambers 46. The nozzle plate 43 is bonded to the flow passage forming substrate 41 by an adhesive agent. The plurality of ink-jet nozzles 45 form a plurality of dot forming means. As shown in FIG. 27, the rows of nozzles 45 (nozzle rows) are arranged perpendicularly to the main scanning direction. In each row of nozzles 45, a pitch between the nozzles 45 is 2×Pn. A distance between the two rows of nozzles 45 is L. In addition, one row of nozzles 45 and the adjacent row of nozzles 45 are mutually shifted by a pitch Pn along the sub scanning direction, so that the nozzles 45 are arranged in a zigzag manner. Accordingly, an image having a pitch Pn can be formed by one main scan and sub scan.

The nozzle plate 43 may be made of a metal such as stainless steel and nickel, a combination of a metal and a resin film made of a polyimide resin, for example, silicon, or a combination thereof. In addition, in order to secure an ink repellant characteristic at the nozzle surface (ink ejecting surface of the nozzle plate 43 having the nozzles 45 through which the ink is ejected), an ink repellant layer is formed on the nozzle surface by a known method such as plating and ink repellant coating.

In the ink-jet head having the structure described above, the piezoelectric elements 52 are selectively applied with a driving pulse voltage of approximately 20 V to 50 V, so that each selected piezoelectric element which is applied with the driving pulse voltage is displaced in the direction in which the layers of the piezoelectric element 52 are stacked. As a result, each selected piezoelectric element 52 deforms the corresponding vibration plate 42 towards the nozzle 45, thereby causing a change in the volume of the corresponding pressure chamber 46. A pressure is thus applied to the ink within the pressure chamber 46, and an ink drop is ejected from the nozzle 45.

The ejection of the ink drop from the nozzle 45 causes the ink pressure within the pressure chamber 46 to fall, and a slight negative pressure is generated within the pressure chamber 46 due to inertia of the ink flow. In this state, when the driving pulse voltage applied to the piezoelectric element 52 is turned OFF, the corresponding vibration plate 42 returns to its original position and the corresponding pressure chamber 46 returns to its original shape (volume), thereby further generating a negative pressure within the pressure chamber 46. In this state, the ink is supplied from the ink supply opening 49 and is supplied into the pressure chamber 46 via the ink supply passage 47 which forms the flow passage resistance portion. Hence, after the vibration of the ink meniscus surface at the nozzle 45 decays and stabilizes, the driving pulse voltage is applied to the piezoelectric element 52 for the next ink ejection.

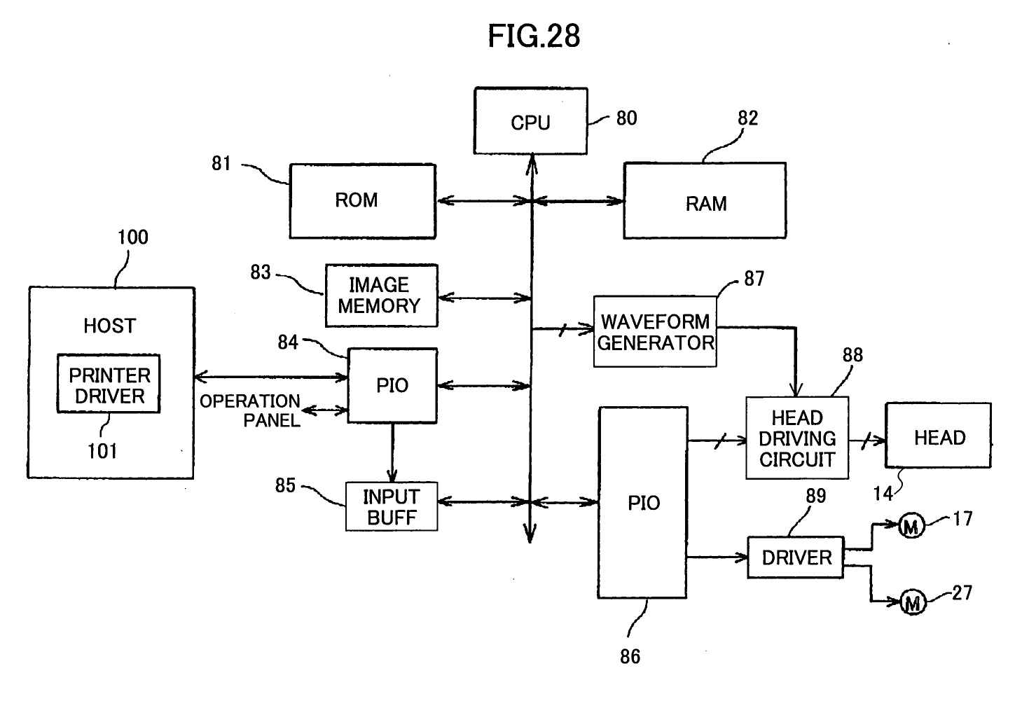

Next, a description will be given of a controller of the ink-jet printer, by referring to FIG. 28. FIG. 28 is a system block diagram generally showing a controller of the ink-jet printer.

The controller shown in FIG. 28 includes a microcomputer (CPU) 80 which generally controls the entire ink-jet printer, a ROM 81 which stores predetermined fixed information, a RAM 82 which is used as a work area, an image memory (raster data memory) 83 which stores image data (dot data or dot pattern data) transferred from a host unit 100, a parallel input and output (PIO) port 84, an input buffer 85, a parallel input an output (PIO) port 86, a waveform generating circuit 87, a head driving circuit 88 and a driver 89.

Various information and data such as the image data transferred from a printer driver 101 of the host unit 100, and detection signals from various sensors are input to the PIO port 84. In addition, predetermined information is output with respect to the host unit 100 and an operation panel (not shown) via the PIO port 84.

The waveform generating circuit 87 generates a driving waveform to be applied to the piezoelectric elements 52 of the recording heads 14. As will be described later, the desired driving waveform can be generated by a simple structure by using a digital-to-analog (D/A) converter which subjects a driving waveform data output from the CPU 80 to a digital-to-analog (D/A) conversion.

The head driving circuit 88 applies the driving waveform from the waveform generating circuit 87 to the piezoelectric elements 52 of the selected channels of the recording heads 14, based on various data and signals received via the PIO port 86. Further, the driver 89 drives and controls the motors 17 and 27 based on driving data received via the PIO port 86, so as to move the carriage 13 in the main scanning direction and rotate the transport roller 24 to transport the paper 3 by a predetermined amount.

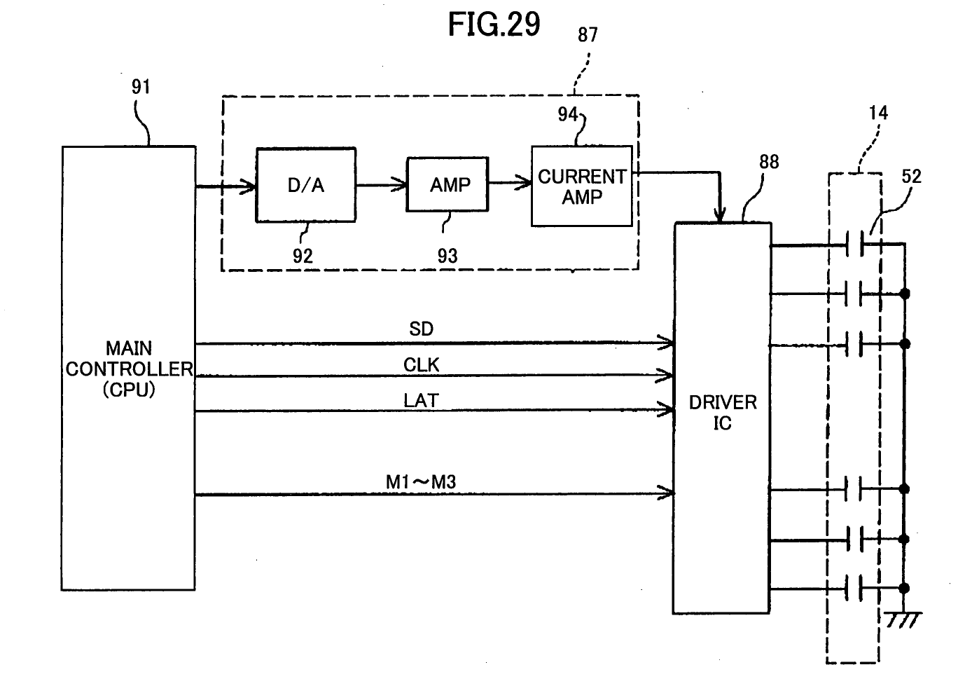

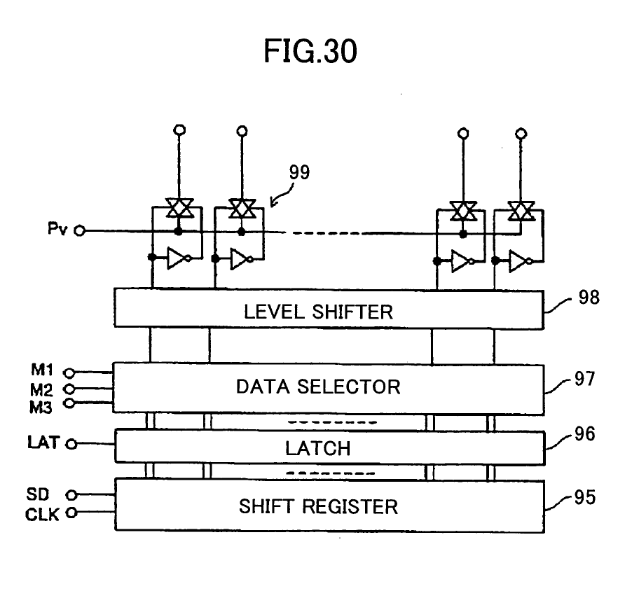

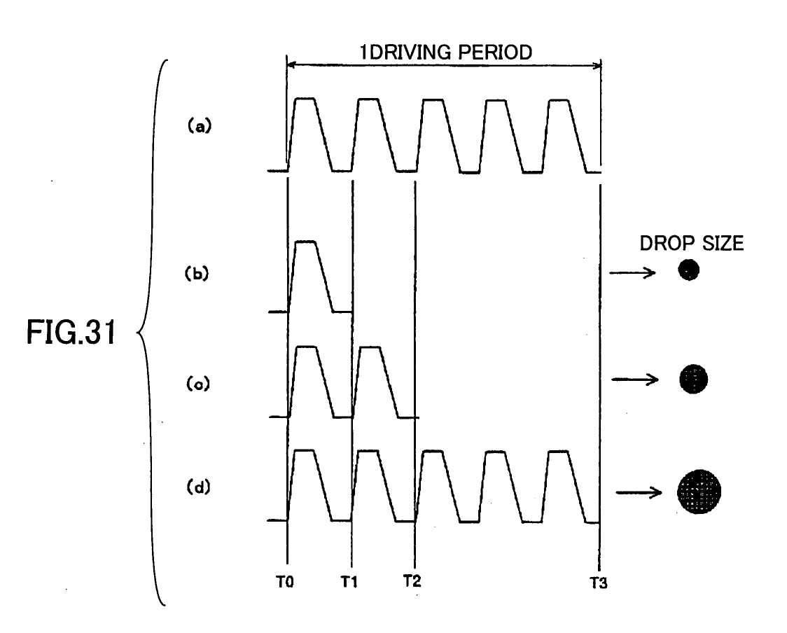

A description will be given of a driving and control section of the controller related to the driving and control of the recording heads 14 will now be described with reference to FIGS. 29 through 31. FIG. 29 is a system block diagram showing the driving and control section of the controller, and FIG. 30 is a system block diagram showing the head driving circuit 88. FIG. 31 is a timing diagram for explaining the operation of the driving and control section.

In FIG. 29, a main controller (CPU) 91 processes front data (dot data) which is received from the host unit 100 as print data, and carries out a vertical-to-horizontal conversion depending on the layout of the recording heads 14. In addition, the main controller 91 generates a 2-bit driving data SD which is required to control the ink drop to a large drop, medium drop and small drop (and no drop or no printing) in correspondence with three-valued (ternary) data, and supplies the 2-bit driving data SD to the head driving circuit (driver IC) 88. The main controller 91 also supplies to the head driving circuit 88 a clock signal CLK, a latch signal LAT, and driving waveform selection signals M1 through M3 for selecting the driving waveform in correspondence with the dot size (size of ink drop) to be formed. Furthermore, the main controller 91 reads driving waveform data stored in the ROM 81, and supplies the driving waveform data to the driving waveform generating circuit 87.

The driving waveform generating circuit 87 includes a D/A converter 92 for converting the driving waveform data received from the main controller 91 into an analog signal, an amplifier 93 for amplifying the output analog signal of the D/A converter 92 to the actual driving voltage, and a current amplifier 94 for amplifying an output of the amplifier 93 to a sufficiently high current capable of driving the recording heads 14. For example, the current amplifier 94 outputs a driving waveform Pv including a plurality of driving pulses within one driving period as shown in FIG. 31(a). The driving waveform Pv is supplied to the head driving circuit 88.

As shown in FIG. 30, the head driving circuit 88 includes a shift register 95 for inputting the driving data SD in response to the clock signal CLK from the main controller 91, a latch circuit 96 for latching the value of the shift register 95 in response to the latch signal LAT from the main controller 91, a data selector 97 for selecting one of the driving waveform selection signals (logic signals) Ml through M3 from the main controller 91 depending on a 1-bit driving data which is latched by the latch circuit 96, a level shifter 98 for shifting an output (logic signal) of the data selector 97 to a driving voltage level, and transmission gates 99 having ON and OFF states thereof controlled by an output of the level shifter 98. The transmission gates 99 receive the driving waveform Pv from the driving waveform generating circuit 87, and is connected to the piezoelectric elements 52 of the corresponding nozzles of the recording heads 14.

Accordingly, in the head driving circuit 88, the data selector selects one of the driving waveform selection signals M1 through M3 depending on the driving data SD, and shifts the selected driving waveform selection signal (logic signal) to the driving voltage level by the level shifter 98. The driving voltage level output from the level shifter 98 is applied to the gates of the transmission gates 99.

As a result, the transmission gates 99 are switched depending on the duration of the selected one of the driving waveform selection signals M1 through M3, and the driving pulses forming the driving waveform Pv are applied to each channel connected to the transmission gate 99 which is ON.

For example, in a case where the driving waveform Pv includes the plurality of driving pulses as shown in FIG. 31(a), each transmission gate 99 which becomes ON only from a time T0 to a time T1 outputs one driving pulse as shown in FIG. 31(b). Hence, when the driving pulse shown in FIG. 31(b) is applied to the piezoelectric element 52, a small ink drop is ejected from the corresponding nozzle. Similarly, each transmission gate 99 which becomes ON only from the time T0 to a time T2 outputs two driving pulses as shown in FIG. 31(c). Thus, when the driving pulse shown in FIG. 31(c) is applied to the piezoelectric element 52, a medium ink drop is ejected from the corresponding nozzle. Further, each transmission gate 99 which becomes ON from the time T0 to a time T3 outputs five driving pulses as shown in FIG. 31(d). Accordingly, when the driving pulse shown in FIG. 31(d) is applied to the piezoelectric element 52, a large ink drop is ejected from the corresponding nozzle.

Therefore, by generating the driving waveform including a plurality of driving pulses and selecting the number of driving pulses to be applied to the piezoelectric element 52, it is possible to generate the necessary driving waveforms for ejecting the small ink drop, medium ink drop and large ink drop from one driving waveform. Consequently, only one circuit is required to generate the driving waveform and only one signal line is required to supply this driving waveform. For this reason, it is possible to reduce the size of the circuit board and transmission lines and also reduce the cost thereof.

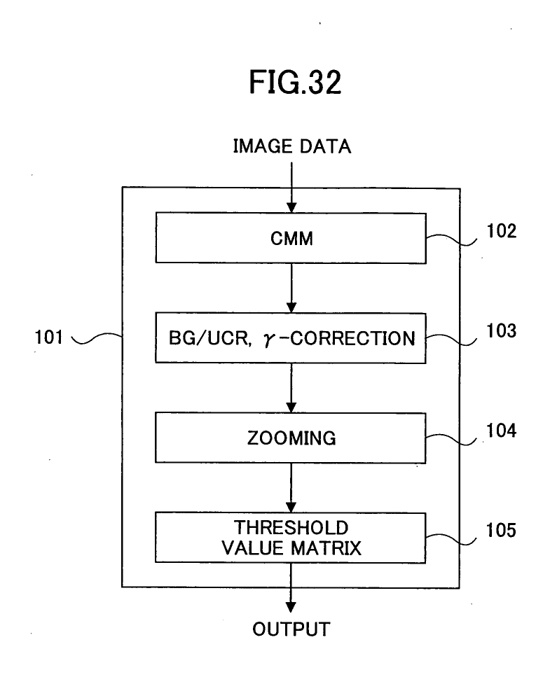

Next, a description will be given of an embodiment of the image processing apparatus according to the present invention, by referring to FIG. 32. FIG. 32 is a system block diagram showing the embodiment of the image processing apparatus. This embodiment of the image processing apparatus is formed by the host unit 100 which transfers the image data and the like to the ink-jet printer, and includes the printer driver 101, that is, an embodiment of the printer driver according to the present invention. The host unit 100 and the printer driver 101 uses an embodiment of the threshold value matrix according to the present invention, and carry out an embodiment of the image processing method according to the present invention, including an embodiment of the gradation reproducing method according to the present invention.

In the case of the embodiment of the image forming apparatus, that is, the ink-jet printer described above, the dot pattern to be actually recorded is received together with a print instruction or command from the host unit 100, and no means is provided within the image forming apparatus to generate the dot pattern to be recorded. Hence, the dot pattern data must be generated by the printer driver 101 which uses the embodiment of the threshold value matrix and executes the embodiment of the gradation reproducing method, and transfer the dot pattern data from the host unit 100 (the embodiment of the image processing apparatus) to the image forming apparatus (ink-jet printer).

As shown in FIG. 32, the printer driver 101 of the host unit 100 includes a color management module (CMM) process section 102, a black generate/under color reduction (BG/UCR) and γ-correction section 103, a zooming process section 104, and a threshold value matrix (table) 105. For example, the image data is generated by an application software of the host unit 100. The image data is processed by the CMM process section 102, the BG/UCR and γ-correction section 103 and the zooming process section 104, and the threshold value matrix (table) 105 is used to convert the multi-level image data into the dot pattern.

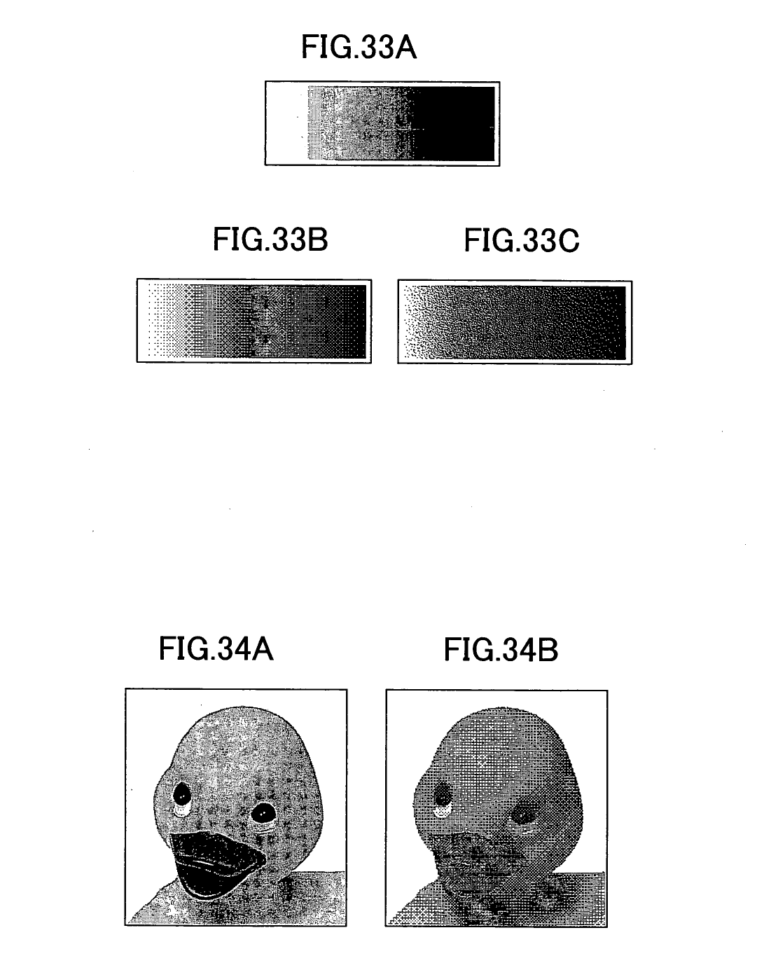

First, a description will be given of the method of creating the threshold value matrix for reproducing the gradation by a predetermined line keytone (dot layout pattern having an aligned property), by referring to FIGS. 33A through 44C.

When carrying out the image processing, if it is possible to realize a high resolution such that the resolution of the formed image exceeds the resolving power of the human eye, the picture quality is theoretically unaffected by the kind of process carried out. But in the case of the resolution of an order which can be recognized by the human eye, there is a possibility that the inconveniences generated by the process itself will become conspicuous to the human eye.

FIGS. 33A, 33B and 33C are diagrams for explaining a dot pattern after carrying out a Bayer type dither process and an error diffusion process with respect to an input image. FIGS. 33A through 33C show the dot patterns which are actually formed by the generally used halftone process for a low-resolution recording of approximately 300 dpi. FIG. 33B shows the output image after carrying out the Bayer type dither process with respect to the input image data shown in FIG. 33A. FIG. 33C shows the output image after further carrying out the error diffusion process.

Hence, in order to reproduce the data which should be represented by one pixel in multi-levels on the image forming apparatus not having a large number of reproducible gradation levels, it is necessary to make a pseudo gradation representation by the number of dots per unit area, that is, by the dot area ratio.

The two kinds of halftone processing methods described as examples of the pseudo gradation representation method, not only simply match the gradation levels and the area ratios, but arranges the dots approximately uniformly so that the dot layout is not biased, and adjusts the dot layout so as to have a high-frequency characteristic which is less conspicuous to the human eye. When such a processing is applied to the high-resolution recording of 600 dpi or 1200 dpi, the dot layout pattern is virtually inconspicuous to the human eye, and it is possible to obtain an extremely satisfactory picture quality having no unevenness in the dot distribution.

On the other hand, when the low-resolution recording of 150 dpi or 300 dpi is carried out, the dot layout pattern becomes conspicuous to the human eye even after the adjusting process to make the dot layout pattern having the high-frequency characteristic. Since one pixel in the original image data is represented by a plurality of pixels by the pseudo gradation representation, a texture pattern not present in the original image appears in the output image.

FIG. 33B shows such a texture pattern. In addition, when an input image data shown in FIG. 34A is output with a considerably low resolution of 72 dpi, the texture pattern becomes even more notable as shown in FIG. 34B. FIGS. 34A and 34B are diagrams for explaining the image data after carrying out the Bayer type dither process with respect to the input image. In FIG. 34B, a portion where the texture peculiar to the Bayer type dither process changes, and a portion where the dots are finely aligned and no texture appears, are mixed to thereby result in a considerably poor picture quality.

On the other hand, in the case of the error diffusion method, the dots are formed with a layout which appears random at first glance. This random dot layout is maintained for all of the gradation levels, and the texture will not change at the gradation levels and no fixed texture exists, as may be seen from FIG. 33C. Because no fixed texture exists, interferences with respect to mechanical deviations in the image forming apparatus are less likely to occur, and a high resolution characteristic is obtainable compared to the Bayer type dither process or the like since there is a certain degree of freedom of the dot layout.

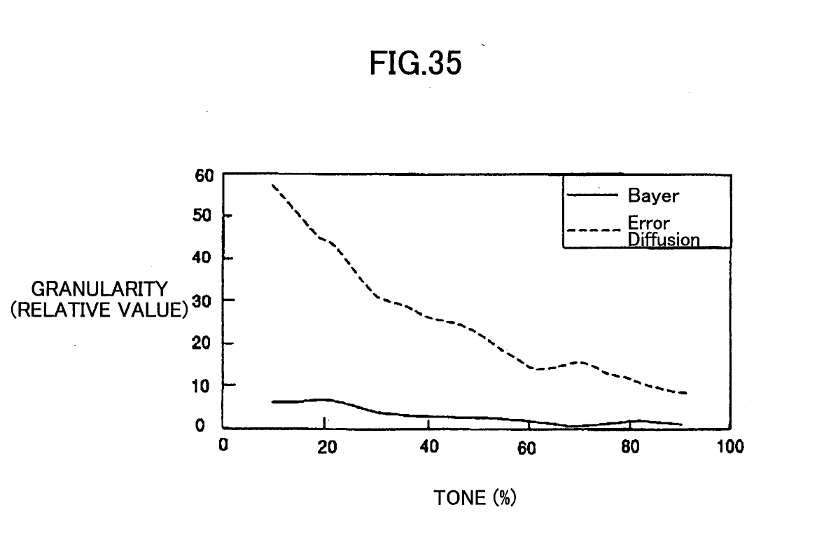

However, according to the error diffusion process, the granularity may be poor when compared to the Bayer type dither process, as shown in FIG. 35. FIG. 35 is a diagram showing the granularity measured at tone intervals of 10% for the Bayer type dither pattern and the error diffusion pattern recorded at 300 dpi. Hence, the random nature of the dot layout used in the error diffusion process, intended to obtain various advantageous effects, actually cause problems at the low resolution. In other words, at the low resolution, a conspicuous noise component is easily recognized in the case of the error diffusion process, and the aligned texture generated in the case of the Bayer type dither process tends to be better when a sensual evaluation is made.

Therefore, it may be understood from the above that the kind of texture pattern formed by the dot layout greatly affects the picture quality. In order to obtain a satisfactory picture quality at the low resolution using the two kinds of halftone processing methods, the present inventors found that it is necessary to form a dot layout pattern having good alignment and not to change the dot layout pattern or not to make the change in the dot layout pattern visible for each of the gradation levels.

In the embodiment of the threshold value matrix, the dot reproduction is made while constantly maintaining a predetermined line keytone (dot layout pattern having an aligned property) for all halftone levels, using only the dot layout pattern. Hence, it is possible to improve the picture quality when making a multi-level representation by a small number of values, on the order of approximately one bit to three bits, during the recording of the image forming apparatus at the low resolution. It is possible to obtain satisfactory recording (print) data particularly when applied to the ink-jet printer employing the dot size (diameter) modulation.

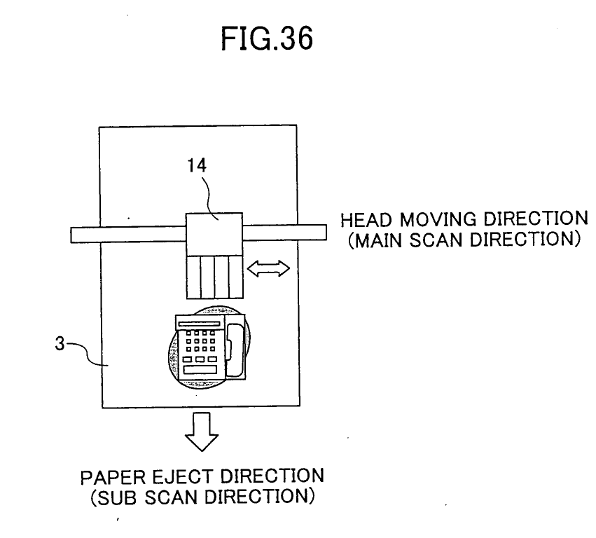

When considering the dot layout pattern having the aligned property (predetermined line keytone), it is always necessary to take into consideration the correlation with the mechanical deviations of the image forming apparatus. In other words, as in the case of the ink-jet printer described above, the recording unit including the recording heads 14 and the carriage 13 carries out the recording while moving in the main scanning direction depending on the transport of the paper 3 as shown in FIG. 36. FIG. 36 is a diagram for explaining the effects of the mechanical deviations in the ink-jet printer. In this case, if inconsistencies exist in the accuracy of the paper transport in the sub scanning direction and the head moving speed in the main scanning direction, an interference may occur with the predetermined line keytone and generate recognizable vertical and horizontal stripes.

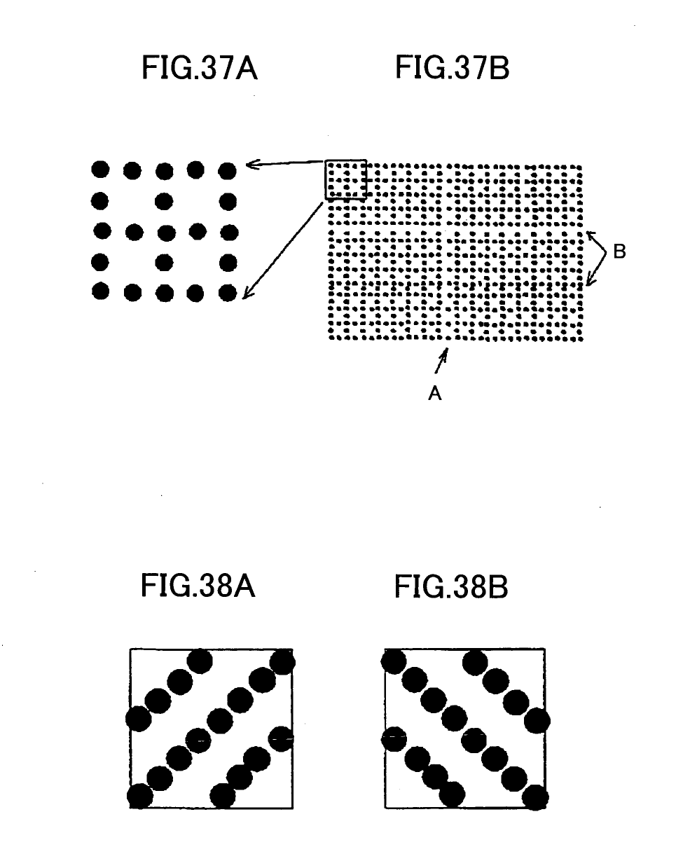

FIGS. 37A and 37B are diagrams for explaining interference between the Bayer type dither pattern and the mechanical deviations of the ink-jet printer. FIG. 37B shows the interference which is generated when outputting one gradation pattern of the Bayer type dither pattern shown in FIG. 37A. It may be seen from FIG. 37B that when the keytone is aligned in the vertical and horizontal directions, a synchronization is easily occurs with deviations A and B in the main and sub scanning directions. Since the human eye is sensitive with respect to the 0-degree and 90-degree (180-degree and 270-degree) directions, it is desirable to avoid the keytone which easily aligns in the vertical and horizontal directions. However, as described above with respect to the error diffusion method, the random dot layout which is least likely to generate the interference is undesirable for the low resolution because the noise component is emphasized and become recognizable.

Accordingly, a dot layout pattern having an inclined keytone is desired, as shown in FIGS. 38A and 38B. FIGS. 38A and 38B are diagrams for explaining the dot layout pattern having the inclined keytone in an embodiment of a threshold value matrix according to the present invention. The same effects can be obtained with respect to deviations in both the main scanning direction and the sub scanning direction, by using a line-group keytone such as a 45-degree inclined keytone and a 135-degree inclined keytone, as shown in FIGS. 38A and 38B. Furthermore, since the human eye is slightly less sensitive with respect to the oblique direction, the inclined keytone tends to be less conspicuous than the vertical and horizontal keytones. But since the main purpose here is to align the keytone, and not to make the interference (which conventionally causes problems) inconspicuous, an advantageous characteristic can be derived therefrom.

The line-group keytones shown in FIGS. 38A and 38B are referred to as “line-group type dither” and used in electrophotography recording. In the electrophotography recording, a latent image is formed on a charged photoconductive body by a laser beam, and the latent image is visualized by a toner into a toner image. The toner image is transferred onto a recording medium such as paper. Hence, the dot size can be controlled in several stages by modulating the laser power, but the electrophotography recording is not suited for making the gradation representation using small dots because the toner adhering and transfer characteristics may deteriorate for small dots. Hence, an area modulated (AM) dither method which gradually forms the large dot by concentrating the dots as much as possible, is generally employed for the electrophotography recording.

The line-group type dither method is a kind of AM dither method. Although the line-group type dither method has directionality, it is advantageous in that the dots can be grown in a spiral manner and that the recording density (number of lines or line density) can be improved compared to the concentration type dither method.

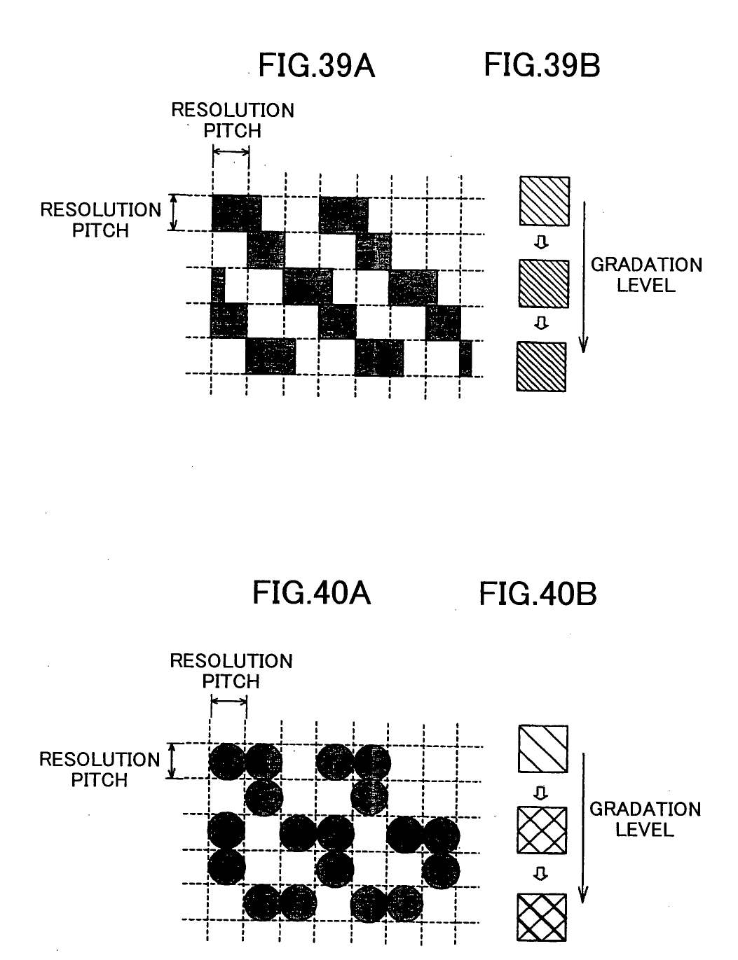

However, when the line-group type dither method used in the electrophotography recording is applied as it is to the ink-jet recording or other recording techniques other than the electrophotography recording, the keytone will not be aligned appropriately. In other words, in the case of the electrophotography recording, it is possible to adjust not only the dot size but also the dot forming position, as may be seen from FIG. 39A. Hence, as may be seen from FIG. 39B, no matter how the dots are arranged, that is, no matter how the gradation level changes, it is possible to represent the gradation levels without destroying the shape of the oblique line. FIGS. 39A and 39B are diagrams for explaining the dot pattern of a line-group keytone used in electrophotography recording and the change in keytone of the gradation level.

On the other hand, when the line-group type dither method used in the electrophotography recording is applied as it is to the ink-jet recording, the dot forming positions are fixed to the pitch determined by the recording resolution, as shown in FIG. 40A. For this reason, the keytone changes even when the number of dots slightly increases, as shown in FIG. 40B, and it is impossible to achieve the original intention which is to realize a processing method which does not change the keytone or does not make the change in keytone conspicuous. FIGS. 40A and 40B are diagrams for explaining the dot pattern of the line-group keytone applied to the ink-jet recording and the change in keytone of the gradation level.

Particularly in the case of the general dither process, the same mask is tiled into square shapes and used, in order to simplify the processing mechanism and achieve high-speed processing at a low cost. Hence, even if the number of dots increases by one dot, this increase is recognized as a pattern which is aligned vertically and horizontally with the tiling period.

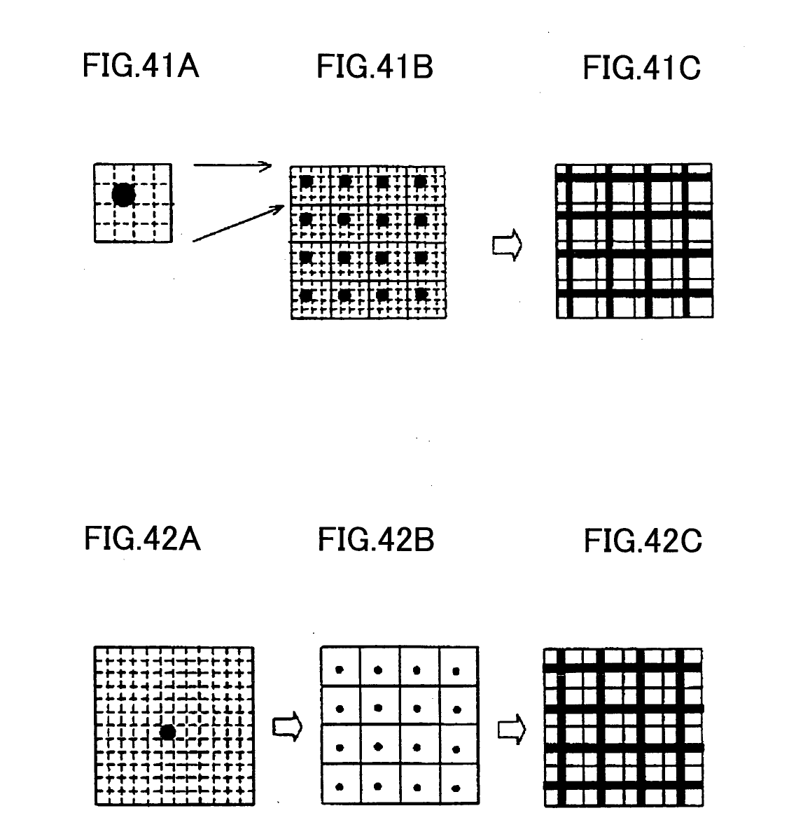

For example, when a 4×4 dither mask shown in FIG. 41A is used to carry out the tiling as shown in FIG. 41B, the dots become aligned as a whole, vertically and horizontally. As a result, a lattice keytone is generated as shown in FIG. 41C. FIGS. 41A, 41B and 41C are diagrams for explaining the keytone formed by tiling the dither mask.

Accordingly, in order to maintain the group-line keytone and to avoid a change in the keytone by this tiling, this embodiment generates three or more dots simultaneously per single gradation level.

In other words, in a case where the reproduction is made by the inclined line-group keytone, when a mask having one dot per single gradation level as shown in FIG. 42A is tiled as shown in FIG. 42B, a lattice keytone which is aligned vertically and horizontally is obtained as shown in FIG. 42C. FIGS. 42A, 42B and 42C are diagrams for explaining the tiling and the keytone for the case where the mask has one dot per gradation level.

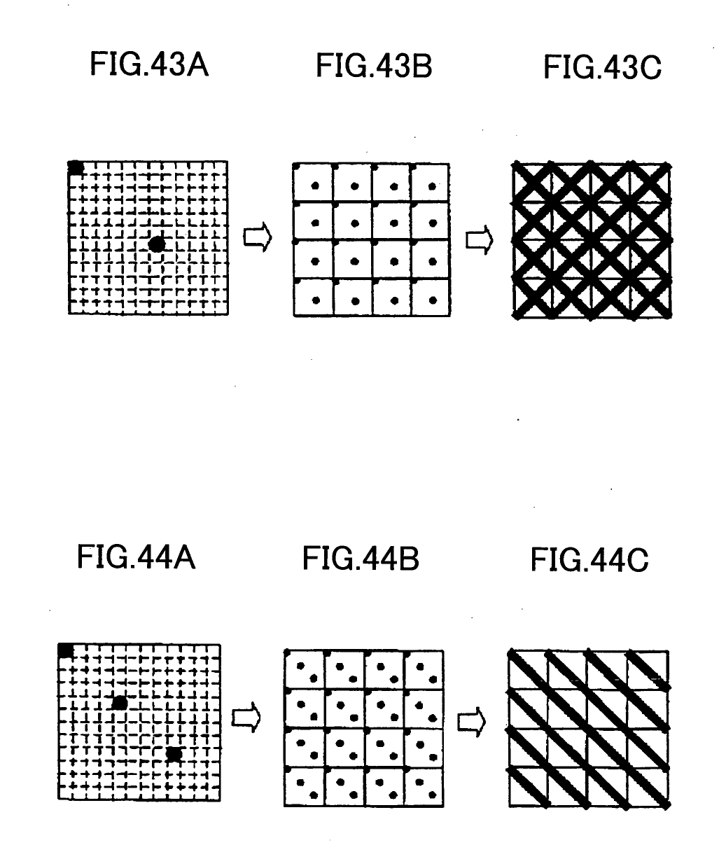

In addition, in a case where the reproduction is made by the inclined line-group keytone, when a mask (having obliquely arrange dot layout) having two dots per single gradation level as shown in FIG. 43A is tiled as shown in FIG. 43B, an inclined keytone which is aligned obliquely is obtained as shown in FIG. 43C. In FIG. 43C, the inclined keytone the 45-degree alignment and the 135-degree alignment which intersect. FIGS. 43A, 43B and 43C are diagrams for explaining the tiling and the keytone for the case where the mask has two dots per gradation level.

On the other hand, in a case where the reproduction is made by the inclined line-group keytone, when a mask having three dots per single gradation level as shown in FIG. 44A is tiled as shown in FIG. 44B, an inclined keytone which is aligned only in one oblique direction is obtained as shown in FIG. 44C. FIGS. 44A, 44B and 44C are diagrams for explaining the tiling and the keytone for a case where the mask has three dots per gradation level. A similar inclined keytone is obtained when the mask has more than three dots per single gradation level.

In this case, simultaneously forming three or more dots per single gradation level, requires a mask size which is 3×3=9 times or greater in order to obtain the same capability of reproducing the gradation levels. This value of 9 time of greater is small compared to the size of the buffer memory or the like required for the error diffusion process. Unless an extremely large mask is used as a reference, this size of the mask size will not decrease the processing speed or increase the cost. Of course, in order to achieve a high-speed processing, it is desirable that the vertical and horizontal sizes of the mask can easily be processed by a computer. In other words, it is desirable to make the mask size a multiple of 8, so that odds are not generated upon development into a memory.

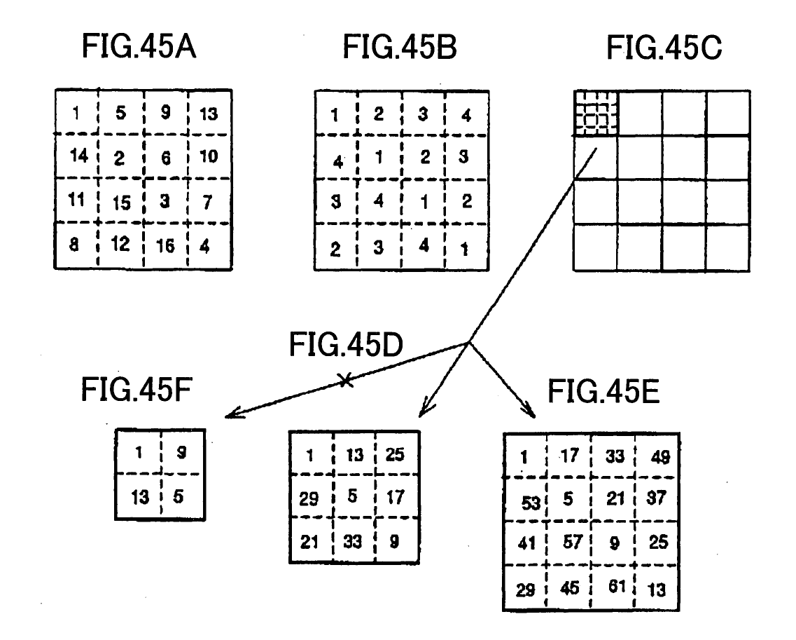

Next, a description will be given of an enlargement of the mask size, by referring to FIGS.45A through 45F. FIGS. 45A through 45F are diagrams for explaining division of a basic matrix into sub matrixes.

When a reference mask shown in FIG. 45A which has the inclined line-group keytone is used as a reference to form a mask shown in FIG. 45B for the case where four dots are simultaneously generated, each cell of the reference mask shown in FIG. 45C is further divided into smaller sub matrixes as shown in FIGS. 45D and 45E so as to obtain the necessary number of gradation levels. In this case, by making the sub matrixes similar figures to the reference mask so as to have the inclined line-group keytone, it is possible to prevent a pattern which destroys the keytone from being generated.

For example, the 3×3 sub matrix shown in FIG. 45D can represent 36 gradation levels. In addition, the 4×4 sub matrix shown in FIG. 45E can represent 64 gradation levels. It is possible to use a 2×2 sub matrix shown in FIG. 45F, but a checkerboard pattern keytone is generated during the process of representing the gradation levels when the 2×2 sub matrix is used. For this reason, this embodiment sets a minimum unit of the sub matrix to be a 3×3 inclined line-group mask.

By using the sub matrixes described above, it is possible to suppress generation of another keytone which would destroy the inclined line-group keytone.

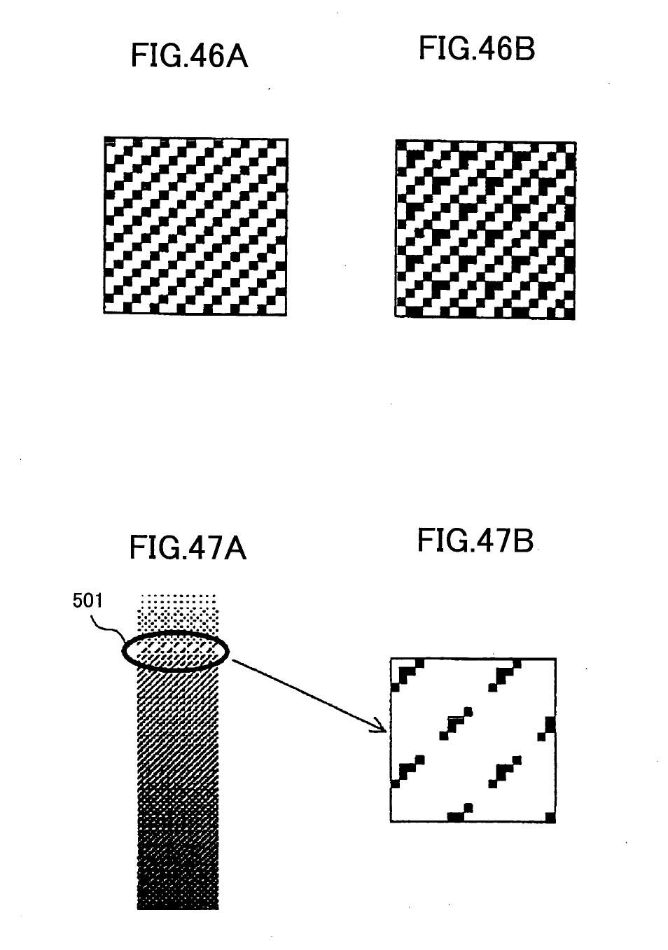

Even when using the threshold value matrix (dither matrix) formed to the line keytone in the predetermined direction as in the case of the line-group keytone described above, a picture quality deterioration may occur at some tones, due to reduced resolution, that is, discontinuity of the gradation levels. In other words, as shown in FIGS. 46A and 46B which show portions of matrix patterns formed to the line keytone in the predetermined direction, there exist tones at which it is difficult to maintain this kind of line keytone. FIGS. 46A and 46B are diagrams for explaining the matrix patterns having the line keytone in the predetermined direction.

FIGS. 47A and 47B are diagrams for explaining a gradation image and a matrix pattern having reduced resolution for a certain tone. For the gradation image shown in FIG. 47A, if the resolution is reduced in the matrix pattern shown in FIG. 47B for the tone of a portion 501, the continuity of the gradation levels may be lost to generate deterioration of the picture quality.

Hence, this embodiment prevents deterioration of the picture quality due to reduced resolution at a certain tone, by selecting a tone range portion with the reduced resolution in the threshold value matrix (dither matrix) formed to the line keytone in the predetermined direction. In addition, the dot layout of the matrix between the tones is readjusted so as to have a highpass filter characteristic and the line keytone in the predetermined direction.

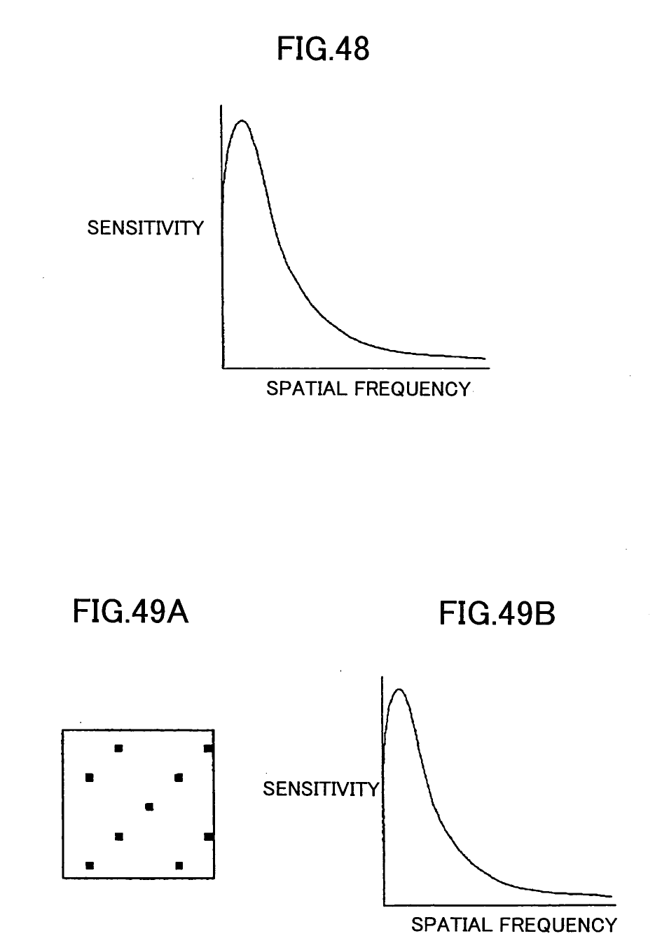

The spatial frequency characteristic of the human vision obtained by spatial frequency analysis is applied to the highpass filter characteristic, to extract the lower spatial frequency characteristic. FIG. 48 is a diagram for explaining the human visual characteristic. In FIG. 48, the ordinate indicates the sensitivity in arbitrary units, and the abscissa indicates the spatial frequency in arbitrary units. The spatial frequency characteristic of the human vision may be approximated by the following formula (4) from a spatial frequency f on the retina.

VTF(f)=5.05(e^{-0.138f})(1−e^{-0.1f}) (4)

FIGS. 49A and 49B are diagrams for explaining a portion, other than the keytone, of a matrix pattern having a highpass filter characteristic. FIG. 49A shows the portion, other than the line keytone, of the matrix pattern having the highpass filter characteristic, and FIG. 49B shows a highpass filter characteristic of this portion other than the line keytone.

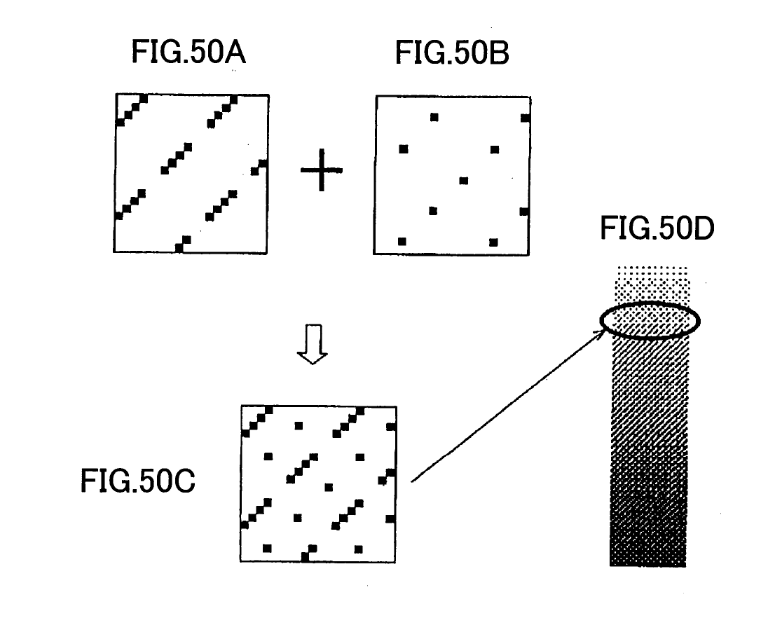

FIGS. 50A, 50B, 50C and 50D are diagrams for explaining a gradation image formed by a matrix having a predetermined line keytone and a highpass filter characteristic at a portion other than the keytone. FIG. 50A shows the portion having the line keytone, FIG. 50B shows the portion other than the line keytone and having the highpass filter characteristic. FIG. 50C shows the dither matrix which is formed by this embodiment based on the portions shown in FIGS. 50A and 50B. Further, FIG. 50D shows the gradation image corresponding to the dither matrix shown in FIG. 50C.

In other words, by using the dither matrix shown in FIG. 50C which is the combination of the portions shown in FIGS. 50A and 50B with respect to the tone portion 501 shown in FIG. 47A,it is possible to obtain the gradation image in which the tone is continuous as shown in FIG. 50D.

Therefore, for the tone for which the continuity of the gradation levels is lost if the line keytone in the predetermined direction is simply formed, the matrix having the highpass filter characteristic in the portion other than the keytone and the predetermined line keytone is used. As a result, it is possible to suppress the deterioration of the resolution (loss of continuity of the gradation levels), and to improve the continuity of the line keytone, thereby improving the quality of the reproduced picture.

In this case, if the dither matrixes for some tones are bi-level images, a highpass filter characteristic is obtained by a difference image of two such bi-level images.

In other words, according to the dither method, a threshold value dot set on the low tone side always exists on the high tone side. Hence, of the two dither matrixes for some tones described above, if the dither matrix for the low tone side is regarded as a mask A and the dither matrix for the high tone side is regarded as a mask B, the line keytone existing in the mask A always exists in the mask B due to the nature of the dither method. Accordingly, if a difference image is obtained by subtracting a binarized image of the mask A from a binarized image of the mask B, this difference image will have no line keytone.

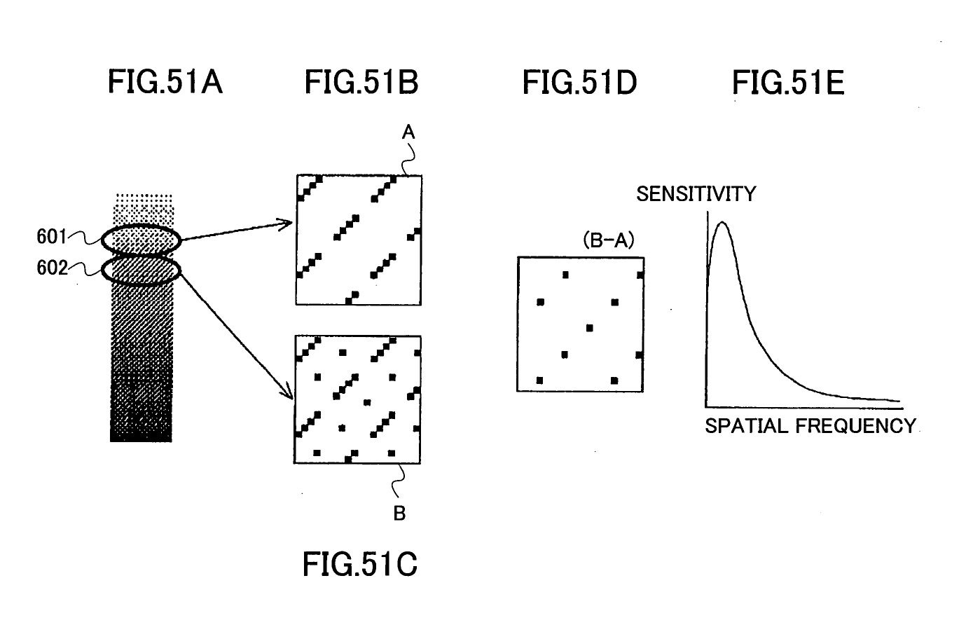

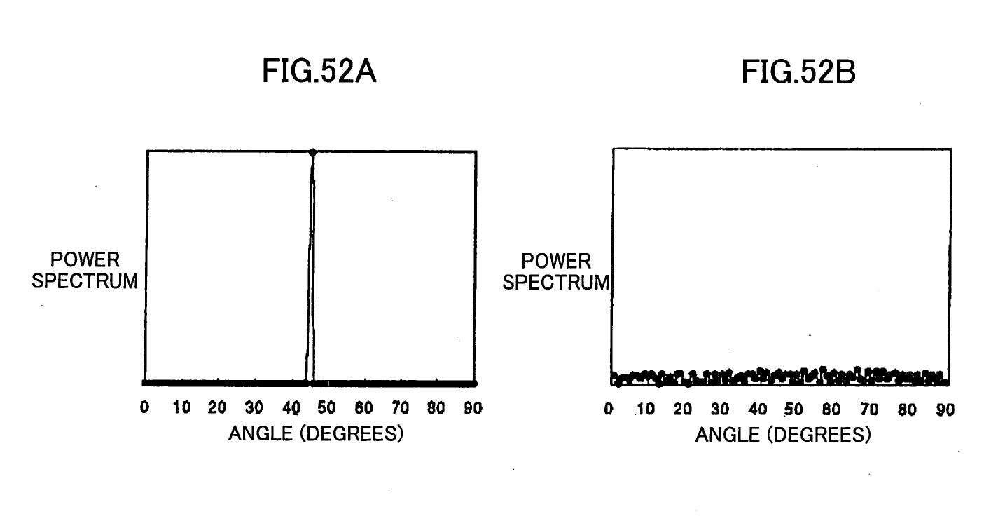

FIGS. 51A, 51B, 51C, 51D and 51E are diagrams for explaining a difference image between matrixes of some tones. In other words, a portion 601 of the gradation image shown in FIG. 51A uses a mask A shown in FIG. 51B, and a portion 602 of the gradation image shown in FIG. 51A uses a mask B shown in FIG. 51C. If a difference (B−A) is obtained between the masks A and B, a difference image (difference pattern) shown in FIG. 51D is obtained. This difference image has a highpass filter characteristic shown in FIG. 51E.

In addition, when this embodiment of the threshold value matrix is applied to some tones of the multi-gradation level image, the power spectrum distributions for angles other than the line keytone in the predetermined direction in the polar coordinates due to two-dimensional spatial frequency become uniformly similar.

In other words, a power spectrum P(u, v) of the image spatial frequency may be defined by the following formula (5), where P denotes a spatial frequency power spectrum of the image, F denotes a spatial frequency amplitude spectrum of the image, and u and v respectively denote spatial frequencies corresponding to x and y axes of the image.

P(u, v)=|F(u, v)|² (5)

The value of the power spectrum P(u, v) indicates the strength of the spatial frequency (u, v). The directionality can be extracted from the spatial frequency (u, v) by describing the spatial frequency (u, v) in polar coordinates P(r, θ) and using the following formula (6), where r denotes a polar coordinate radius of the power spectrum, θ denotes a polar coordinate angle of the power spectrum, q denotes a θ-direction component of the power spectrum, and w denotes a sampling frequency of the image.

$$q ( θ ) = {\sum }_{r = 0}^{w / 2} P ( r , θ ) \qquad ( 6 )$$

As described above, the threshold value matrix of this embodiment is formed to the line keytone in the predetermined direction, and has the highpass filter characteristic in the portion other than the keytone. Since the portion having the line keytone includes the line keytone in only the predetermined direction, the power spectrum in the polar coordinates has a strong value only for the angle in the predetermined direction. In addition, because the portion other than the line keytone has the highpass filter characteristic, the power spectrum values in the polar coordinates become uniformly similar.

FIGS. 52A and 52B are diagrams for explaining a power spectrum distribution in polar coordinates of the matrix. FIG. 52A shows the power spectrum in the polar coordinates of this embodiment of the threshold value matrix. In addition, FIG. 52B shows a power spectrum distribution in the polar coordinates excluding the line angle of 45 degrees. As may be seen from FIG. 52A, only the 45-degree portion has a strong value in the power spectrum in the polar coordinates of the threshold value matrix. On the other hand, the value is uniformly similar in the power spectrums in the polar coordinates excluding the 45-degree portion.

Accordingly, the threshold value matrix is formed to the 45-degree direction of the line keytone, and the values are uniformly similar due to the highpass filter characteristic in the power spectrums other than the 45-degree direction.

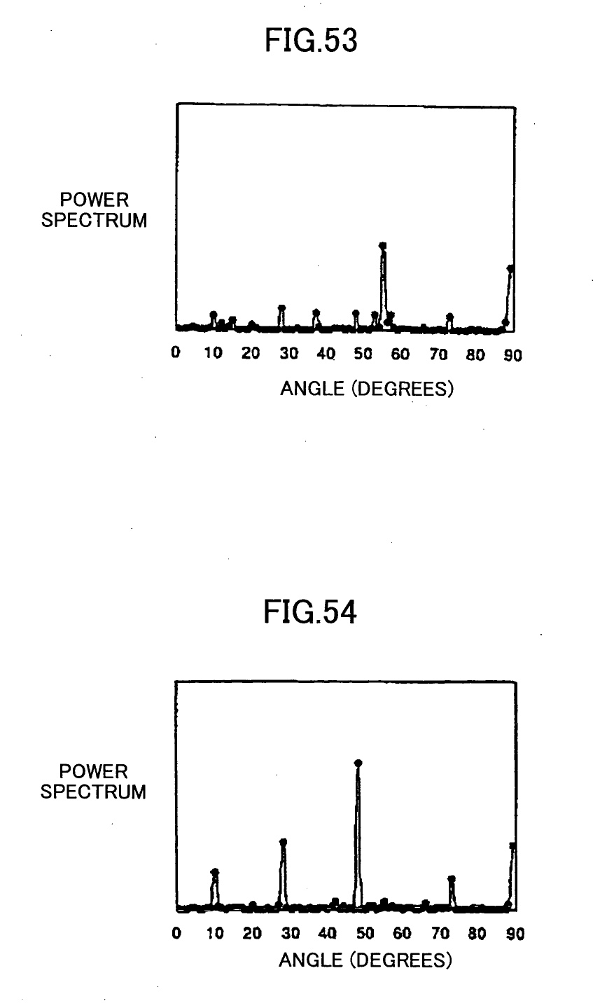

As described above, the Bayer type dither matrix and the concentration type dither matrix are typical mask techniques of the conventional systematic dither method. FIG. 53 is a diagram for explaining a power spectrum distribution in polar coordinates of the Bayer type dither matrix, and FIG. 54 is a diagram for explaining a power spectrum distribution in polar coordinates of the concentration type dither matrix, with respect to the same tone as FIGS. 52A and 52B. As may be seen from FIGS. 53 and 54, the power spectrum value has a high value at a plurality of angles, unlike in FIG. 52A where the power spectrum value has a high value only at the 45-degree angle.

Therefore, the continuity of the line keytone in the predetermined direction is improved by the threshold value matrix which suppresses deterioration of the resolution, and it is possible to reproduce a multi-gradation level image having a desired quality using the continuous gradation representation. In addition, compared to the error diffusion method, the process is simplified by the use of the mask technique, and it is possible to increase the processing speed, to enable high-speed printing, high-speed image processing or high-speed image formation. In this case, by employing the line-group keytone which sets the predetermined direction of the line keytone to an oblique direction, the line keytone in the oblique direction reduces the horizontal stripe noise in the image forming apparatus, thereby enabling output of a multi-gradation level image having an extremely high quality.

The threshold value matrix and the gradation reproducing method described above may be applied to a multi-color image processing method which decomposes a multi-color image into a plurality of color components and uses an original image of at least one color component as the input image. In this case, it is possible to output a multi-color image having a high picture quality.

In a multi-color image forming apparatus, such as the general color printer, three basic colors cyan, magenta and yellow are used for the printing. In addition, in the color ink-jet printer, in order to improve the perceived color by taking into consideration the lightness and the like, black is used in addition to the three colors. Hence, the popular color printers use four basic colors to print a full color image. Furthermore, in order to improve the picture quality of the prints, color printers which use more colors have also been proposed, by preparing one or more colors which are combinations of two or more basic colors.

According to the multi-color image forming method employed in these multi-color image forming apparatuses, which decomposes the original multi-color image into a plurality of color components and uses the original images of the color components as the input images, the pseudo gradation representation process is carried out in units of the color components. For this reason, the continuity of the line keytone is improved in units of the color components when the present invention is applied, and as a result, it is possible to form an monochrome or multi-color image having a high picture quality.

Particularly in the case of the image forming apparatus which uses the threshold value matrix to convert each dot into bi-level or multi-level image data, it is possible to increase the image forming speed and the printing speed and to improve the picture quality, by applying the present invention to the image formation at a low resolution of 300 dpi or less.

In other words, in the general image forming apparatus which uses the pseudo gradation representation process, the picture quality is improved by increasing the dot density per unit area, that is, by increasing the resolution. However, increasing the resolution simultaneously increases the amount of image data to be processed per unit area, to thereby increase the processing time. In the case of the image forming apparatus having the resolution of 300 dpi, it is generally considered a maximum limit of the pseudo gradation representation process to represent approximately 150 lines per inch, which is the reason why it is generally considered difficult to realize a high picture quality.

But in the case of the pseudo gradation representation process using the dither matrix having the line keytone in the predetermined direction, the deterioration of the resolution occurs to the human vision for some tones, and the resolution is further reduced at 300 dpi, thereby losing continuity of the gradation representation and making the deterioration of the picture quality conspicuous. Hence, by applying the present invention when forming the image on the image forming apparatus having such an output format (that is, output at a low resolution), it is possible to suppress the deterioration of the resolution and improve the continuity of the line keytone in the predetermined direction, so that a multi-gradation level image having a desired picture quality is formed by a continuous gradation representation.

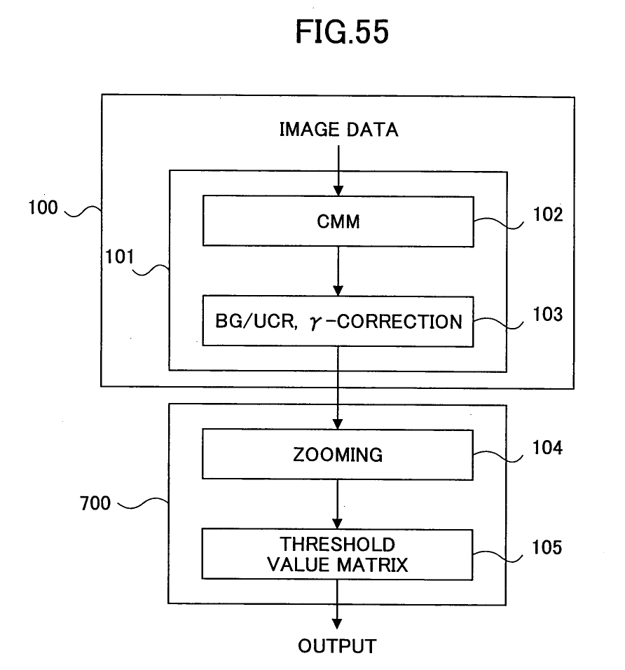

In the embodiment described above, the threshold value matrix is held in the form of a table in the printer driver 101 of the host unit 100. However, it is possible to employ a structure shown in FIG. 55.

FIG. 55 is a system block diagram showing another embodiment of the image forming apparatus according to the present invention. In the host unit 100 shown in FIG. 55, the printer driver 101 includes only a CMM process section 102 and a BG/UCR and γ-correction section 103, which process the image data from application software or the like executed by the host computer 100. A zooming process section 104 and a threshold value matrix (table) 105 are provided in a controller of an ink-jet printer 700. The threshold value matrix (table) 105 is formed by a ROM or the like which stores the threshold value matrix of the present invention. Hence, the conversion of the dot layout is made in the ink-jet printer 700 in this case. But regardless of whether the conversion of the dot layout is made in the host unit 100 or the ink-jet printer 700, it is possible to make a 1:1 comparison process with respect to the input image data, thereby enabling image processing at a high speed and a low cost.

In the embodiment described above, the present invention is applied in particular to the host unit and the ink-jet printer (image forming apparatus). However, the present invention is similarly applicable to any type of image forming apparatus which forms an image by dots, that is, forms the image by dot representation. Hence, the present invention is applicable to thermal transfer type image forming apparatuses (printers), for example. The present invention is also applicable to electrophotography type image forming apparatuses such as laser printers and LED printers.

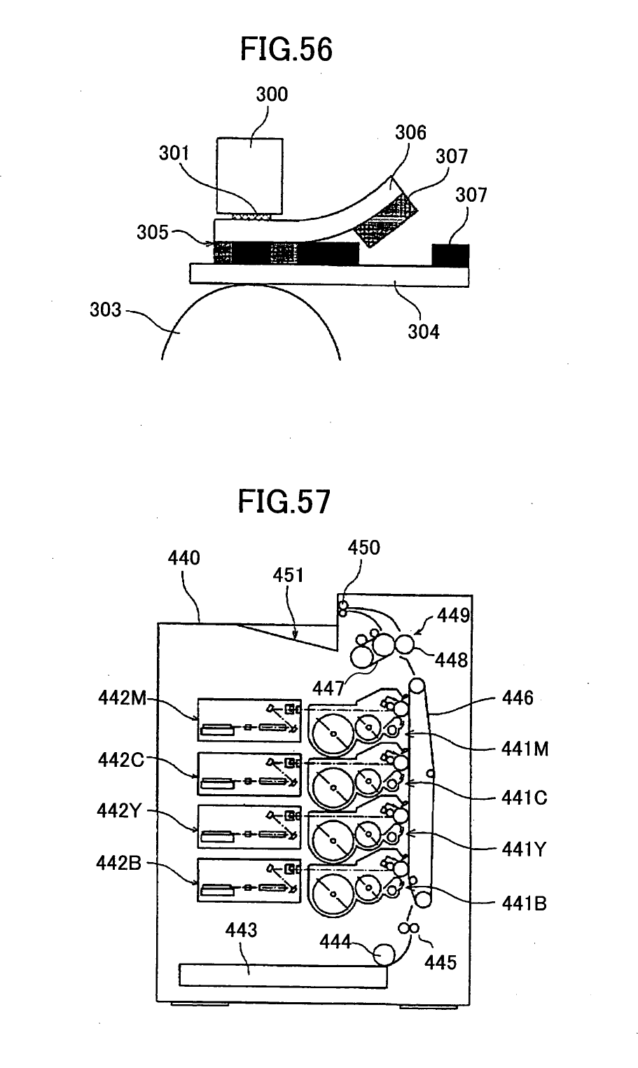

FIG. 56 is a diagram generally showing a thermal transfer type image forming apparatus. As shown in FIG. 56, a paper 304 and an ink sheet 305 are transported between a pressure roller 303 and a thermal head 300 which is provided with a heating element 301. By driving the heating element 301 of the thermal head 300, a wax layer 307 in a predetermined region of a base layer 306 of the ink sheet 105 is transferred onto the paper 304 to thereby form an image on the paper 304.

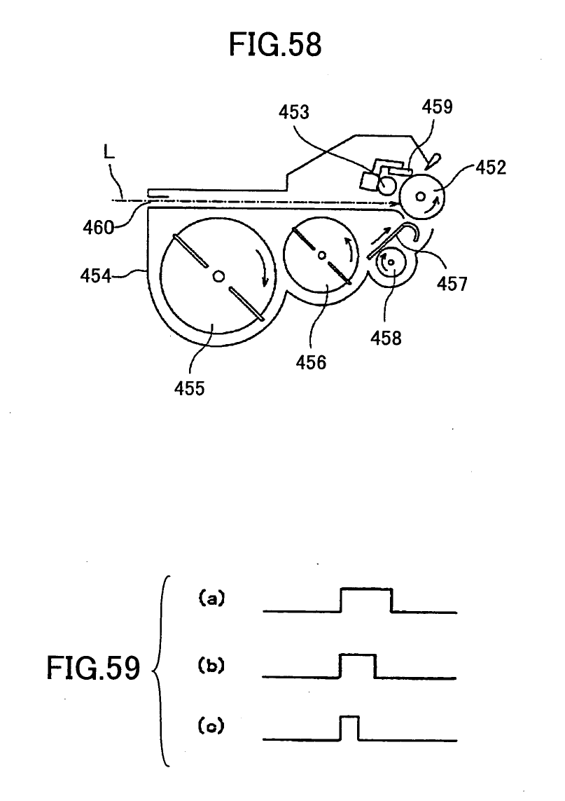

FIG. 57 is a diagram generally showing an electrophotography type image forming apparatus. FIG. 58 is a diagram generally showing a process cartridge of the electrophotography type image forming apparatus.

An image forming apparatus 440 shown in FIG. 57 is a kind of laser printer which forms a full color image using four basic colors of magenta (M), cyan (C), yellow (Y) and black (Bk). The image forming apparatus 440 generally includes four optical write (recording) units 442M, 442C, 442Y and 442Bk for emitting laser beams depending on image signals of the corresponding colors M, C, Y and Bk, four process cartridges 441M, 441C, 441Y and 441Bk for forming images in colors M, C, Y and Bk, and a paper supply cassette 443 which accommodates recording paper on which the images are to be transferred. A paper supply roller 444 supplies the recording paper from the paper supply cassette 443, and a resist roller 445 transports the recording paper at a predetermined timing. A transfer belt 446 transports the recording paper to a transfer portion of each of the process cartridges 441M, 441C, 441Y and 441Bk. A fixing unit 449 fixes the image transferred onto the recording paper. A paper eject roller 450 ejects the recording paper after the fixing onto a paper eject tray 451.

The four process cartridges 441M, 441C, 441Y and 441Bk have the same structure shown in FIG. 58. As shown in FIG. 58, the process cartridge integrally includes within a casing a drum-shaped photoconductive body 452 which is provided as an image bearing member, a charging roller 453, a developing unit 454, and a cleaning blade 459.

A toner supply roller, a charging roller, an electrostatic transport plate 457 and a toner return roller 458 are provided within the developing unit 454, and toner of a corresponding color is accommodated within the developing unit 454. In addition, a slit 460 through which the laser beam from the corresponding optical write unit enters is provided in a rear surface of the process cartridge 441.

Each of the optical write units 442M, 442C, 442Y and 442Bk includes a semiconductor laser, a collimator lens, an optical deflector such as a polygonal mirror, and a scanning and imaging optical system, and emits a laser beam which is modulated depending on the image data of the corresponding color input from the host unit (image processing apparatus) such as a personal computer provided externally to the image forming apparatus. The laser beams from the optical write units 442M, 442C, 442Y and 442Bk scan the photoconductive bodies 452 of the corresponding process cartridges 441M, 441C, 441Y and 441Bk, so as to write electrostatic latent images on the photoconductive bodies 452.

When the image formation starts, the photoconductive body 452 of each of the process cartridges 441M, 441C, 441Y and 441Bk is uniformly charged by the charging roller 453, and the laser beam from each of the optical write units 442M, 442C, 442Y and 442Bk scans the photoconductive body 452 of the corresponding one of the process cartridges 441M, 441C, 441Y and 441Bk, so as to write electrostatic latent image on the photoconductive body 452. The electrostatic latent image formed on the photoconductive body 452 is developed and visualized into a toner image by the toner of the corresponding color electrostatically transported by the electrostatic transport plate 457 of the developing unit 454. A pulse-shaped developing bias is applied between confronting portions of the photoconductive body 452 and the electrostatic transport plate 457 for the developing and visualization of the electrostatic latent image into the toner image. The toner not used for the developing is transported by the electrostatic transport plate 457 and returned by the toner return roller 458.

The recording paper within the paper supply cassette 443 is supplied by the paper supply roller 444 in synchronism with each color image formation at the process cartridges 441M, 441C, 441Y and 441Bk, and is transported towards the transfer belt 446 by the resist roller 445 at a predetermined timing. The recording paper is carried by the transfer belt 446 and successively transported to pass by the photoconductive body 452 of each of the process cartridges 441M, 441C, 441Y and 441Bk. Hence, the toner images of each of the colors Bk, Y, C and M are successively transferred onto the recording paper in an overlapping manner. The recording paper having the toner images of the four colors transferred thereon in the overlapping manner is transported to the fixing unit 449 which includes a fixing belt 447 and a pressure roller 448, and a full color toner image is fixed on the recording paper. The recording paper is then ejected onto the paper eject tray 451 by the paper eject roller 450.

FIG. 59 is a timing diagram for explaining a dot size change in this electrophotography type image forming apparatus. FIG. 59(a), FIG. 59(b) and FIG. 59(c) show various ON and OFF times of the laser beam which is emitted from each of the optical write units 442M, 442C, 442Y and 442Bk. It is possible to change the dot size formed on the photoconductive body 452 by changing the ON and OFF times of the laser beam as shown.

Of course, the structure of the recording head of the ink-jet printer described above is not limited to that of the described embodiment, and various other structures may be used, such as a thermal type ink-jet head which uses a heating resistor and an electrostatic type ink-jet head which uses a vibration plate and an electrode. In addition, although the present invention is applied to the image forming apparatus in the described embodiments, it is also possible to similarly apply the present invention for the image processing and gradation representation when outputting image data to an image display apparatus.

Further, the present invention is not limited to these embodiments, but various variations and modifications may be made without departing from the scope of the present invention.

1. A threshold matrix creating method which creates a plurality of threshold value matrixes for quantizing multi-level image data into three or more valued data in order to represent halftone by ON and OFF states of a plurality of kinds of dots, comprising:
a first stage which determines a threshold value layout order of the threshold value matrixes for binarizing the multi-level image data in order to represent the halftone by ON and OFF states of one kind of dot; and
a second stage which creates each of a plurality of threshold value matrixes for quantizing the multi-level image data into three or more valued data, according to the threshold value layout order determined by said first stage.

2. The threshold value matrix creating method as claimed in claim 1, wherein said first stage includes:
selecting random gradation levels from all gradation sections;
determining a dot layout of the selected gradation level according to optimizing conditions;
determining a dot layout of each gradation level between a starting side gradation level and an ending side gradation level which are selected, according to the optimizing conditions based on optimized dot layouts of the starting side and ending side gradation levels; and
determining the threshold value layout order of the threshold value matrixes for the binarization, based on the determined dot layout of each gradation level.

3. The threshold value matrix creating method as claimed in claim 2, wherein said first stage includes:
carrying out an adjusting process to include the optimized dot layout of the starting side gradation level in an initial dot layout pattern of the ending side gradation level; and
determining the dot layout of the ending side gradation level according to the optimizing conditions, based on the initial dot layout pattern after the adjusting process, while maintaining the dot layout of the starting side gradation level.

4. A computer-readable storage medium which stores a program for causing a computer to create a plurality of threshold value matrixes for quantizing multi-level image data into three or more valued data in order to represent halftone by ON and OFF states of a plurality of kinds of dots, said program comprising:
a first procedure which causes the computer to determine a threshold value layout order of the threshold value matrixes for binarizing the multi-level image data in order to represent the halftone by ON and OFF states of one kind of dot; and
a second procedure stage which causes the computer to create each of a plurality of threshold value matrixes for quantizing the multi-level image data into three or more valued data, according to the threshold value layout order determined by said first procedure.

5. The computer-readable storage medium as claimed in claim 4, wherein said first procedure includes:
causing the computer to select random gradation levels from all gradation sections;
causing the computer to determine a dot layout of the selected gradation level according to optimizing conditions;
causing the computer to determine a dot layout of each gradation level between a starting side gradation level and an ending side gradation level which are selected, according to the optimizing conditions based on optimized dot layouts of the starting side and ending side gradation levels; and
causing the computer to determine the threshold value layout order of the threshold value matrixes for the binarization, based on the determined dot layout of each gradation level.

6. The computer-readable storage medium as claimed in claim 5, wherein said first procedure includes:
causing the computer to carry out an adjusting process to include the optimized dot layout of the starting side gradation level in an initial dot layout pattern of the ending side gradation level; and
causing the computer to determine the dot layout of the ending side gradation level according to the optimizing conditions, based on the initial dot layout pattern after the adjusting process, while maintaining the dot layout of the starting side gradation level.

7. An image output system comprising:
a first section which determines a threshold value layout order of a plurality of threshold value matrixes for binarizing the multi-level image data in order to represent the halftone by ON and OFF states of one kind of dot;
a second section which creates each of a plurality of threshold value matrixes for quantizing the multi-level image data into three or more valued data, according to the threshold value layout order determined by said first section; and
a third section which quantizes the multi-level image data into the three or more valued data in order to represent halftone by ON and OFF states of a plurality of kinds of dots, using the threshold value matrix created by said second section.

8. The image output system as claimed in claim 7, wherein said first section includes:
means for selecting random gradation levels from all gradation sections;
means for determining a dot layout of the selected gradation level according to optimizing conditions;
means for determining a dot layout of each gradation level between a starting side gradation level and an ending side gradation level which are selected, according to the optimizing conditions based on optimized dot layouts of the starting side and ending side gradation levels; and
means for determining the threshold value layout order of the threshold value matrixes for the binarization, based on the determined dot layout of each gradation level.

9. The image output system as claimed in claim 8, wherein said first section includes:
means for carrying out an adjusting process to include the optimized dot layout of the starting side gradation level in an initial dot layout pattern of the ending side gradation level; and
means for determining the dot layout of the ending side gradation level according to the optimizing conditions, based on the initial dot layout pattern after the adjusting process, while maintaining the dot layout of the starting side gradation level.

10. A gradation reproducing method comprising:
converting a multi-gradation image into a bi-level or multi-level image data representing each dot by a bi-level or multi-level representation using a dither matrix,
said dither matrix having a line keytone in a predetermined direction for at least some of tones of the multi-gradation image, and having a highpass filter characteristic at portions other than the line keytone.

11. The gradation reproducing method as claimed in claim 10, wherein a difference image of two bi-level images corresponding to certain tones of the dither matrix has a highpass filter characteristic.

12. The gradation reproducing method as claimed in claim 10, wherein power spectrum distributions for angles other than the line keytone in the predetermined direction in polar coordinates due to two-dimensional spatial frequency are uniformly similar for certain tones of the dither matrix.

13. The gradation reproducing method as claimed in claim 10, the keytone is a line-group keytone.

14. A threshold value matrix for converting a multi-gradation image into a bi-level or multi-level image data representing each dot by a bi-level or multi-level representation, comprising:
a line keytone in a predetermined direction for at least some of tones of the multi-gradation image; and
a highpass filter characteristic at portions other than the line keytone.

15. The threshold value matrix as claimed in claim 14, wherein a difference image of two bi-level images corresponding to certain tones of the dither matrix has a highpass filter characteristic.

16. The threshold value matrix as claimed in claim 14, wherein power spectrum distributions for angles other than the line keytone in the predetermined direction in polar coordinates due to two-dimensional spatial frequency are uniformly similar for certain tones of the dither matrix.

17. The threshold value matrix as claimed in claim 14, the keytone is a line-group keytone.

18. An image processing method comprising:
decomposing a multi-color image into a plurality of color components; and
converting an original image of at least one of the color components into a bi-level or multi-level image data representing each dot by a bi-level or multi-level representation using a dither matrix,
said dither matrix having a line keytone in a predetermined direction for at least some of tones of the multi-gradation image, and having a highpass filter characteristic at portions other than the line keytone.

19. An image processing apparatus comprising:
a section which decomposes a multi-color image into a plurality of color components; and
a section which converts an original image of at least one of the color components into a bi-level or multi-level image data representing each dot by a bi-level or multi-level representation using a dither matrix,
said dither matrix having a line keytone in a predetermined direction for at least some of tones of the multi-gradation image, and having a highpass filter characteristic at portions other than the line keytone.

20. An image processing apparatus comprising:
means for decomposing a multi-color image into a plurality of color components; and
means for converting an original image of at least one of the color components into a bi-level or multi-level image data representing each dot by a bi-level or multi-level representation using a dither matrix,
said dither matrix having a line keytone in a predetermined direction for at least some of tones of the multi-gradation image, and having a highpass filter characteristic at portions other than the line keytone.

21. An image forming apparatus comprising:
a decomposing section which decomposes a multi-color image into a plurality of color components;
a converting section which converts an original image of at least one of the color components into a bi-level or multi-level image data representing each dot by a bi-level or multi-level representation using a dither matrix; and
an imaging section which forms an image from a plurality of dots depending on an output of said converting section,
said dither matrix having a line keytone in a predetermined direction for at least some of tones of the multi-gradation image, and having a highpass filter characteristic at portions other than the line keytone.

22. An image forming apparatus comprising:
decomposing means for decomposing a multi-color image into a plurality of color components;
converting means for converting an original image of at least one of the color components into a bi-level or multi-level image data representing each dot by a bi-level or multi-level representation using a dither matrix; and
imaging means for forming an image from a plurality of dots depending on an output of said converting means,
said dither matrix having a line keytone in a predetermined direction for at least some of tones of the multi-gradation image, and having a highpass filter characteristic at portions other than the line keytone.

23. The image forming apparatus as claimed in claim 22, wherein said imaging means forms the image on a recording medium by a recording technique selected from a group consisting of an ink-jet recording, a thermal transfer recording, and electrophotography recording.

24. A printer driver, to be implemented in a computer, for supplying an output image data to an image forming apparatus which forms an image from a plurality of dots, comprising:
decomposing means for decomposing a multi-color image into a plurality of color components; and
converting means for converting an original image of at least one of the color components into a bi-level or multi-level image data representing each dot by a bi-level or multi-level representation using a dither matrix, so as to generate the output image data,
said dither matrix having a line keytone in a predetermined direction for at least some of tones of the multi-gradation image, and having a highpass filter characteristic at portions other than the line keytone.
